(19) United States
(12) Patent Application Publication
(10) Pub. No.: US 2025/0328802 A1
(43) Pub. Date: Oct. 23, 2025

(54) AGENT ROUTE OPTIMIZATION USING QUANTUM COMPUTING

(71) Applicant: PwC Product Sales LLC, New York, NY (US)

(72) Inventors: Bibhash MITRA, Burdwan (IN); Arit Kumar BISHWAS, San Francisco, CA (US); Saurabh CHOUDHARY, Bhandara (IN); Joseph David VOYLES, Louisville, KY (US)

(73) Assignee: PwC Product Sales LLC, New York, NY (US)

(21) Appl. No.: 18/583,410

(22) Filed: Feb. 21, 2024

(51) Int. Cl. G06N 10/60

(52) U.S. Cl. CPC G06N 10/60

(57) ABSTRACT

Techniques for determining an optimized quantity of agents and routes for agents may include determining a plurality of locations within a geographic region to be visited by a plurality of agents, generating a sequence objective function, inputting the sequence objective function and sequence conditions into a quantum computing system to determine a sequence solution, generating an agent quantity objective function to identify a minimum quantity of agents to visit the locations, generating a temporal duration objective function, and inputting the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.

### FIELD

This application relates generally to optimizing agent routing using quantum computing, such as quantum annealers.

### BACKGROUND

Deciding the number of agents or personnel needed to perform a set of tasks can be tedious and time consuming. However, these decisions can have a major impact on the profitability, performance, and efficiency of certain operations. Further complicating matters is determining which routes are to be assigned to those agents. This problem, referred to as the agent route optimization problem, is an important NP-hard problem for which a solution is needed. Classical algorithms, such as genetic algorithms based on greedy methods, can be used to solve these types of NP-hard problems. However, these classical algorithms are computationally expensive and slow. Techniques are needed to further optimize these techniques to develop improved solutions to NP-hard problems, like the agent route optimization problem.

### SUMMARY

There are several real-life problems which either cannot be solved by classical computing techniques or will take an impractical amount of time to be solved by classical computing techniques. One example of such real-life problems includes the agent route optimization problem, also referred to as the “multi-agent path finding” problem. The agent route optimization problem comprises determining an optimum number of agents needed to visit a plurality of locations using the most efficient routes. Each agent visits at least one location and no location is visited by more than one agent. The agent route optimization problem has applications in logistics, shipping, traffic routing, video gaming, transportation, navigation, and supply chain management, amongst others.

Described herein are techniques for determining an optimized solution to the agent route optimization problem. These techniques include a two-step process. During a first step, quantum computing can be used to determine an optimized route for an agent to visit each of a plurality of locations. The optimized route represents an order in which the agent is to visit each location so as to minimize distance traveled and/or travel time. During a second step, quantum computing is used again to determine a minimum number of agents needed to visit the locations, which agent is to visit which locations, and an order with which each agent is to visit their respective locations while adhering to one or more conditions. For example, the conditions to be adhered to may include that the amount of time needed for an agent to visit each of their locations should be less than a threshold amount of time (e.g., a conventional workday of about 8 hours), no two agents should visit the same location, and no location visited more than once.

A provided method for determining an optimized quantity of agents and routes for the agents using quantum computing may comprise determining, using a classical computing system, a plurality of locations within a geographic region to be visited by a plurality of agents, generating, using the classical computing system, a sequence objective function to identify a sequence with which the plurality of locations are to be visited that minimizes a total distance traveled, inputting the sequence objective function and a set of sequence conditions into a quantum computing system to determine a sequence solution comprising the identified sequence, generating, using the classical computing system, an agent quantity objective function to identify a minimum quantity of agents from the plurality of agents to visit the plurality of locations based on the sequence solution, generating, using the classical computing system, a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations; and inputting the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations. The quantum computing system may include a plurality of qubits.

A quantity of qubits included within the plurality of qubits used by the quantum computing system to determine the optimized solution can be based on a quantity of locations included within the plurality of locations. In various embodiments, the quantity of qubits comprises 1,000 or more qubits, 10,000 or more qubits, 20,000 or more qubits, 50,000 or more qubits, or 100,000 or more qubits.

A provided method can further comprise defining a cost function comprising a binary matrix, the binary matrix comprising a plurality of elements and mapping the plurality of elements of the binary matrix respectively to a plurality of qubits of the quantum computing system. Each row of the binary matrix may correspond to an agent of a plurality of agents and each column of the binary matrix may correspond to a position within the sequence. Each of the plurality of elements may have a first value or a second value. The first value may correspond to a first state of a qubit from the plurality of qubits indicating that, for the optimized solution, an agent of the plurality of agents travels to that location at that position within the sequence. The second value may correspond to a second state of a qubit from the plurality of qubits indicating that, for the optimized solution, the agent does not travel to that location at that position within the sequence. Generating the agent quantity objective function may include summing the binary matrix across the plurality of agents to determine whether each row includes at least one element has the first value. Generating the temporal duration objective function may comprise summing the binary matrix across the plurality of agents to determine a first amount of time for each of the plurality of agents to travel from a center of the geographic region to a given location of the plurality of locations, a second amount of time for each of the plurality of agents to travel from an immediately previous location to the given location, and a third amount of time for each of the plurality of agents to travel from the immediately previous location to the center. The temporal duration objective function may include a first component for determining the first amount of time based on the binary matrix and a first distance matrix comprising distances from the center to each of the plurality of locations, a second component for determining the second amount of time based on the binary matrix and a second distance matrix comprising distances from the immediately previous location to the given location, and a third component for determining the third amount of time based on the binary matrix and a third distance matrix comprising distances from the immediately previous location to the center.

The set of agent-quantity conditions may include a first condition that the amount of time for an agent of the plurality of agents to visit each location of the subset of locations assigned to the agent is less than or equal to a threshold amount of time, a second condition that each of the plurality of locations is included within the sequence with which the plurality of locations are to be visited, and a third condition that each location of the plurality of locations is visited by only one agent. The agent may perform a task at each location of the subset of locations and the task may take a predefined amount of time to complete. The amount of time for the agent to visit each location of the subset of locations assigned to the agent can be determined based on: (i) the predefined amount of time to perform the task, (ii) a quantity of locations included by the subset of locations assigned to the agent, and (iii) a distance between each location of the subset of locations assigned to the agent.

Determining the plurality of locations may involve receiving geographic data comprising a plurality of longitudes-latitudes pairs describing the plurality of locations. A provided method can include calculating, based on the geographic data, a center of the geographic region, wherein the center comprises a center longitude and a center latitude. The temporal duration objective function may comprise a first component representing, for each of the plurality of agents, an amount of time for the agent to travel from the center to each of the plurality of locations, a second component representing, for each of the plurality of agents, an amount of time for the agent to travel from an immediately prior location of the plurality of locations to each of the plurality of locations, and a third component representing, for each of the plurality of agents, an amount of time for the agent to travel from the immediately prior location to the center. Generating the temporal duration objective function may involve combining, for each of the plurality of agents, the first component, the second component, and the third component.

The agent quantity objective function and the temporal duration objective function may each include a matrix comprising rows representing a plurality of candidate agents and columns representing candidate locations to be visited by a corresponding agent. The minimum quantity of agents may be determined from the plurality of candidate agents. A provided method can include removing, from the plurality of candidate agents, any agents determined to not travel to at least one of the plurality of locations. The agent quantity objective function and the temporal duration objective function may be solved, via the quantum computing system, together.

Generating the sequence objective function may comprise calculating a plurality of distances, wherein each distance of the plurality of distances is between two of the plurality of locations and formulating a distance matrix comprising the plurality of distances. The sequence objective function may include the distance matrix. Generating the sequence objective function can involve defining a cost function comprises a product of the distance matrix and a binary matrix, the binary matrix comprising a plurality of elements, and mapping the plurality of elements of the binary matrix respectively to a plurality of qubits of the quantum computing system. Each row of the binary matrix may correspond to an agent of a plurality of agents and each column of the binary matrix corresponds to a position within the sequence. Each of the plurality of elements may have a first value or a second value. The first value may correspond to a first state of a qubit from the plurality of qubits indicating that, for the optimized solution, an agent of the plurality of agents travels to that location at that position within the sequence, and The second value may correspond to a second state of a qubit from the plurality of qubits indicating that, for the optimized solution, the agent does not travel to that location at that position within the sequence. The cost function may include a constrained quadratic model.

The sequence solution comprising the sequence may represent a shortest distance to travel to each of the plurality of locations. The set of sequence conditions may include a first condition that each location of the plurality of locations is traveled to a single time and a second condition that each location of the plurality of locations occupies a single position within the sequence.

In some embodiments, a method for determining an optimized quantity of agents and routes for the agents using quantum computing comprises receiving, using a classical computing system, geographic data comprising a collection of locations within a geographic region to be visited by a plurality of agents, determining, using the classical computing system, that a quantity of locations included within the collection of locations fails to satisfy a threshold location quantity condition, and splitting, using the classical computing system, the collection of locations into a plurality of sets of locations, wherein a quantity of locations included within each of the plurality of sets of locations satisfies the threshold location quantity condition. For each of the plurality of sets of locations, the method can comprise generating, using the classical computing system, a sequence objective function to identify a sequence with which the set of locations are to be visited that minimizes a total distance traveled, inputting the sequence objective function and a set of sequence conditions to a quantum computing system to determine a sequence solution comprising the identified sequence, generating, using the classical computing system, an agent quantity objective function to identify a minimum quantity of agents to visit the set of locations based on the sequence solution, generating, using the classical computing system, a temporal duration objective function to identify a plurality of subsets of locations of the set of locations to be visited by one or more of the plurality of agents based on the sequence solution, wherein each of the plurality of subsets of locations is assigned to one of the plurality of agents to minimize an amount of time for that agent to visit the subset of locations, and inputting the agent quantity objective function, the temporal duration objective function, and a set of agent-quantity conditions to the quantum computing system to determine an optimized solution comprising the minimum quantity of agents, the subset of locations to be traveled to by each of the agents in the minimized amount of time, and an order with which the agent is to travel to each of subset of locations. The method can include generating, using the classical computing system, a global solution based on the optimized solution determined for each of the plurality of sets of locations. The quantum computing system may include a plurality of qubits, the threshold location quantity condition is determined based on a quantity of the plurality of qubits. The threshold location quantity condition being satisfied may comprise the quantity of locations being less than or equal to a threshold quantity of locations, the threshold quantity of locations being determined based on the quantity of the plurality of qubits.

A provided system for determining an optimized quantity of agents and routes for the agents using quantum computing may include memory storing computer program instructions and one or more processors programmed with the computer program instructions to determine a plurality of locations within a geographic region to be visited by a plurality of agents, generate a sequence objective function to identify a sequence with which the plurality of locations are to be visited that minimizes a total distance traveled, input the sequence objective function and a set of sequence conditions into a quantum computing system to determine a sequence solution comprising the identified sequence, generate an agent quantity objective function to identify a minimum quantity of agents from the plurality of agents to visit the plurality of locations based on the sequence solution, generate a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations, and input the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.

A provided non-transitory computer-readable medium may store computer program instructions that, when executed by one or more processors, effectuate operations comprising determining a plurality of locations within a geographic region to be visited by a plurality of agents, generating a sequence objective function to identify a sequence with which the plurality of locations are to be visited that minimizes a total distance traveled, inputting the sequence objective function and a set of sequence conditions into a quantum computing system to determine a sequence solution comprising the identified sequence, generating an agent quantity objective function to identify a minimum quantity of agents from the plurality of agents to visit the plurality of locations based on the sequence solution, generating a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations, and inputting the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed can be resorted to by those skilled in the art, and that such modifications and variations are considered to be within the scope of this invention as defined by the appended claims.

### BRIEF DESCRIPTION OF THE DRAWINGS

FIG. 1 illustrates an example system for determining an optimized quantity of agents and routes for the agents using quantum computing, in accordance with various embodiments.

FIG. 2 illustrates an example geographic region including a plurality of locations to be visited by a plurality of agents, in accordance with various embodiments.

FIG. 3 illustrates an example process for determining an optimized quantity of agents and routes for the agents using a two-step process, in accordance with various embodiments.

FIG. 4 illustrates a flowchart of an example method for determining an optimized quantity of agents and routes for the agents using quantum computing, in accordance with various embodiments.

FIG. 5 illustrates a flowchart of another example method for determining an optimized quantity of agents and routes for the agents using quantum computing, in accordance with various embodiments.

FIG. 6 illustrates an example computer system used to implement some or all of the techniques described herein.

### DETAILED DESCRIPTION

There are several real-life problems which cannot be solved using classical computing techniques or take an impractical amount of time to solve using classical computing techniques. One example of such real-life problems is the agent route optimization problem. The agent route optimization problem comprises determining an optimum number of agents needed to visit a plurality of locations using the most efficient routes. Each agent visits at least one location and no location is visited by more than one agent. Solutions to the agent route optimization problem are used to identify efficient operations and settings where a multi-agent network is used to perform tasks at various end points.

The agent route optimization problem is considered an NP-hard problem. NP-hard problems refer to a class of problems where every problem P in NP (non-deterministic polynomial time) can be reduced in polynomial time. NP-hard problems can be found in cryptography, data mining, scheduling, routing, and other areas. While many NP-hard problems cannot be solved practically using classical computing techniques, solutions to some NP-hard problems can be obtained using quantum computing techniques. The agent route optimization problem is one such example.

Described herein are techniques for determining a solution to the agent route optimization problem by leveraging quantum computing. These techniques include executing a two-step process. During the first step, quantum computing may be used to determine an optimized route for an agent to visit a plurality of locations. During the second step, quantum computing is used again to determine a minimum number of agents needed to visit all of the locations, which agents are to visit which locations, and an order with which each agent is to visit their respective locations, while adhering to one or more conditions. For example, the conditions may include: an amount of time for an agent to visit each of their locations being less than a threshold amount of time (e.g., a conventional workday of about 8 hours), no two agents are to visit the same location, and no location is to be visited more than once.

Some existing classical techniques can be used to solve, or attempt to solve, NP-hard problems like the agent routing optimization problem. For example, techniques like Ant colony Optimization, Particle Swarm Optimization, and so on, can be used. Unfortunately, these classical techniques are difficult to scale to real-world scenarios. For instance, as the number of locations included within the route increases, it can become difficult to compute solutions using classical techniques, even using high-performance supercomputers.

The agent route optimization problem may be solved using quantum computing. In some examples, to solve optimization problems via quantum computing, the optimization problem may be reformatted as a model that includes binary variables having associated linear and quadratic biases. These types of models can be referred to as quadratic binary optimization (QUBO) functions. Alternatively, the optimization problem can be formulated as a model that includes binary variables defining the cost function and constraints, without needing the simplified QUBO function. Formatting the model in this manner can increase efficiency as well as simplify the modelling process.

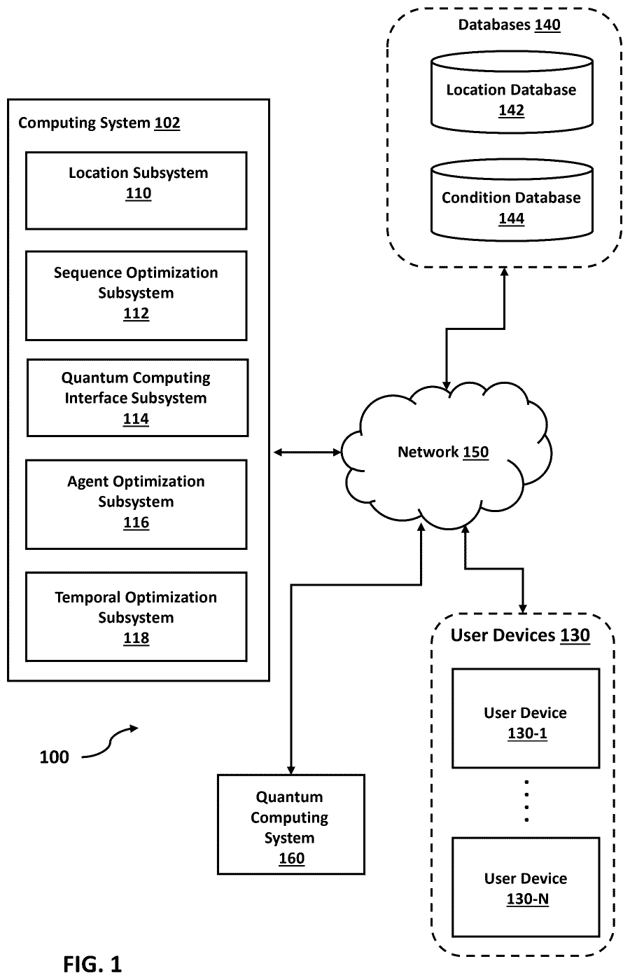

FIG. 1 illustrates an example system 100 for determining an optimized quantity of agents and routes for the agents using quantum computing, in accordance with various embodiments. System 100 may include a computing system 102, user devices 130-1 to 130-N (e.g., collectively referred to as “user devices 130”), databases 140 (e.g., location database 142, condition database 144), a quantum computing system 160, or other components. In some embodiments, components of system 100 may communicate with one another using network 150, such as the Internet. In some examples, computing system 102 corresponds to a “classical” computing system to distinguish from quantum computing system 160. As described in greater detail herein, a classical computing system may perform classical computing operations, whereas a quantum computing system may execute quantum computing operations (e.g., quantum annealing).

User devices 130 may be capable of communicating with one or more components of system 100 via network 150 and/or via a direct connection. User devices 130 may refer to computing devices configured to interface with various components of system 100 to control one or more tasks, cause one or more actions to be performed, or effectuate other operations. For example, user devices 130 may be configured to provide inputs to computing system 102 and/or quantum computing system 160 via network 150. Example computing devices that user devices 130 may correspond to include, but are not limited to, which is not to imply that other listings are limiting, desktop computers, servers, mobile computers, smart devices, wearable devices, cloud computing platforms, or other client devices. In some embodiments, each user device 130 may include one or more processors, memory, communications components, display components, audio capture/output devices, image capture components, or other components, or combinations thereof. Each user device 130 may include any type of wearable device, mobile terminal, fixed terminal, or other device.

It should be noted that, while one or more operations are described herein as being performed by particular components of computing system 102, user devices 130, and/or quantum computing system 160, those operations may, in some embodiments, be performed by other components of system 100. As an example, while one or more operations are described herein as being performed by components of computing system 102, those operations may, in some embodiments, be performed by components user devices 130. It should also be noted that, although some embodiments are described herein with respect to machine learning models, other prediction models (e.g., statistical models or other analytics models) may be used in lieu of or in addition to machine learning models in other embodiments (e.g., a statistical model replacing a machine-learning model and a non-statistical model replacing a non-machine-learning model in one or more embodiments). Furthermore, although a single instance of computing system 102 and quantum computing system 160 are depicted within system 100, additional instances of one or more of computing system 102 and/or quantum computing system 160 may be included.

Classical computers, such as computing system 102, perform calculations using information represented by binary digits (or “bits” for short). Each bit in a classical computing system can occupy one of two discrete states: a first state (“0”) or a second state (“1”). In the absence of any external forces, a classical system such as a bit will occupy a single, well-defined state indefinitely. On the other hand, quantum computers (e.g., quantum computing system 160) perform calculations using information encoded in the quantum states of two-state quantum systems called “quantum bits” (or “qubits” for short). A quantum system can “collapse,” with a certain probability, to any physically allowed state when a measurement of the system's state is performed. Since the measurement result is probabilistically determined, several measurements of the state of the same quantum system will not necessarily yield the same result. This is because, unlike a classical system—which can only exist in one of its possible states—a quantum system such as a qubit can exist in any “superposition” (i.e., combination) of the independent, physically distinguishable quantum states in which the system can be observed or measured. This superposition state contains information about each of the possible independent quantum states as well as information related to the probability of observing the quantum system in each of the possible independent states. Since a quantum superposition state contains more information than a classical state, a single qubit (which can exist in any superposition of two independent states) is capable of representing a greater amount of information than a single classical bit (which can exist in only a single state at a time). As a result, quantum computers, such as are theorized to be capable of solving complex computational problems which classical computers are incapable of solving in practical amounts of time.

Although quantum computing systems, such as quantum computing system 160, have the potential to solve problems that classical computers cannot, such as NP-hard problems, quantum computing systems present various design challenges. Quantum computers store information in the quantum states of qubits. As such, the ability to accurately and precisely control the quantum states of qubits is absolutely essential to the development of scalable, functioning quantum computing systems. Quantum systems, however, are inherently fragile. Thus, storing information in a quantum state for extended periods of time is difficult. Small fluctuations (e.g., thermal fluctuations) in the environment surrounding a system of qubits, for example, can disturb the state of the system and cause “decoherence,” which renders the quantum information contained in the qubit system inaccessible. One method of controlling the qubit states is to house systems of qubits in cryogenic environments (i.e., environments at temperatures below about −180° C./−292° F./93 K). Maintaining the controlled environment at cryogenic temperatures can reduce thermal fluctuations in the controlled environment, which may otherwise disturb the state of the qubit system. However, maintaining the environment at cryogenic temperatures means the any physical hardware used within the controlled environment must be capable of operating efficiently in a cryogenic environment. In addition, other mechanisms of qubit control beyond controlling the environment are needed in order to successfully perform quantum computations. These control mechanisms need to be scalable, accurate, and capable of functioning alongside one another.

Quantum computing system 160 may implement one or more types of quantum technology. Some example types of quantum technology include gate-based ion trapped processors, gate-based superconducting processors, photonic processors, neutral atom processors, Rydberg atom processors, quantum annealers, or other technologies. As an example, if quantum computing system 160 is a quantum annealer, a solution to a problem being solved by the quantum annealer having qubits placed in an absolute energy minimum. The quantum computing systems configurations can be altered to reflect the type of problem to be solved.

In some examples, quantum computing system 160 may employ a quantum annealing approach. In one or more examples, quantum computing system 160 may comprise 10 or more qubits, 100 or more qubits, 1,000 or more qubits, 5,000 or more qubits, and the like. In one or more examples, quantum computing system 160 may comprise 100 or more couplers, 1,000 or more couplers, 10,000 or more couples, and the like. For example, quantum computing system 160 may comprise 40,000 or more couplers and 20,000 or more qubits, Quantum computing system 160 may include millions of Josephson junctions forming the superconducting integrated circuit. Due to the large number of connections, quantum computing system 160 having the parameters described above can be used to embed large problems with lesser physical qubits.

Quantum computing system 160 may include one or more quantum processing units (QPUs). The QPU's can dictate the translation of a QUBO or Ising objective function into a format that quantum computing system 160 can solve. Such binary objective functions can be represented as graphs, which can in turn can be mapped to the QPU. The QPU's architecture may include a repeated structure where each qubit is coupled to one or more oppositely aligned and one or more similarly aligned, qubits. A basic unit cell may include such qubits each coupled to one similarly aligned qubit in the cell and two similarly aligned qubits in adjacent cells, Alternative quantities of qubits may also be employed. In some embodiments, the global structure can be seen as a system of diagonally arranged bicliques, with couplers between oppositely aligned qubits both within and between the diagonals.

Some quantum-classical hybrid solvers can be used to solve arbitrary application problems formulated as quadratic models. In one or more examples, quantum computing system 160 may implement a quantum-classical hybrid solver. In some embodiments, objective functions (e.g., a sequence objective function, an agent quantity objective function, a temporal duration objective function) may be submitted directly to quantum computing system 160 (along with their respective conditions). For example, quantum optimization data may be encoded using a binary quadratic model (BQM) format or a constrained quadratic model (CQM) format. These models may include binary-valued variables structured for the topology of a quantum processing unit (QPU). Hybrid solvers may accept arbitrarily structured quadratic models (QM), constrained or unconstrained, with both integer and binary variables. These solvers, which implement state-of-the-art classical algorithms together with intelligent allocation of the quantum computer to parts of the problem where it benefits most, are designed to accommodate even very large problems.

Quantum computing system 160 may execute a solving process, which may take time to complete. The execution times can be of the order of 10-20 ms. The access time can be segmented into a one-time initialization step to program the QPU(s) of quantum computing system 160 (i.e., programming time) and sampling times for execution on the QPU(s) (i.e., sampling time) of quantum computing system 160. In order to be fair and measure only the time taken to obtain one solution in the quantum machine, the sampling time, which is broken down into anneal (anneal time), the read of the sample from the QPU (readout time) and thermalization (time for the QPU to hit again its initial temperature, delay time) may be used. The time taken to obtain each solution may then be given by the sum of the QPU times for each sample: anneal time, readout time, and delay time.

In some embodiments, computing system 102 may formulate one or more optimization problems to be solved by quantum computing system 160. In one or more examples, the optimization problems may be formulated as problems consisting of binary variables with associated linear and quadratic biases, such as a quadratic binary optimization (QUBO) function. The QUBO function can be expressed using Equation 1:

$${f}_{Q} ( x ) = {x}^{T} Q x = {\sum }_{i = 1}^{n} {\sum }_{j = 1}^{n} {Q}_{ij} {x}_{i} {x}_{j} . \qquad Equation 1$$

Solving the QUBO problem includes determining a binary vector x′ that is minimal with respect to the function ƒ_{Q}(x):

$${x}^{′} = {arg min}_{x ∈ {ℝ}^{n}} {f}_{Q} ( x ) . \qquad Equation 2$$

In Equations 1 and 2, Qᵢⱼ refers to a real-valued upper triangular matrix whose elements define weights for pairs i, jϵ{1, . . . , n} within a binary vector. If the weight of xᵢ and xⱼ is 1, then the weight of Qᵢⱼ is added.

In one or more examples, the optimization problems may alternatively be formulated as a problem consisting of binary variables but without the requiring the simplified QUBO function, which makes the process both efficient and simpler. This type of function, which may be referred to as a constrained quadratic function, can be expressed using Equation 3:

$$min ( {\sum }_{i} {a}_{i} {x}_{i} + {\sum }_{i \leq j} {b}_{ij} {x}_{i} {x}_{j} + c ) . \qquad Equation 3$$

In Equation 3, xᵢ and xⱼ refer to binary vectors each including binary, integer, or continuous variables, and aᵢ, bᵢⱼ, and c are real values. The objective of Equation 3 may be to minimize the function subject to constraints:

$${\sum }_{i} {a}_{i}^{( m )} {x}_{i} + {\sum }_{i \leq j} {b}_{i}^{( m )} {x}_{i} {x}_{j} + {c}^{( m )} ∘ 0 , m = 1 , … , M . \qquad Equation 4$$

In Equation 4, {xᵢ}_{i=1, . . . , N} may be a binary variable, an integer variable, or a continuous variable; aᵢ, bᵢⱼ, and c are real values; ∘ϵ{≥, ≤; =}; and M represents the total number of constraints. In some examples, this formulation of the optimization problem may correspond to an Ising format.

In some embodiments, computing system 102 may solve the agent route optimization problem using a two-step approach:

First, a most efficient route may be determined using quantum computing system 160. The most efficient route may correspond to a route that covers each location of the collection of locations within the geographic region. The most efficient route may correspond to the route that takes the least time and/or is the shortest distance while traveling to each of the locations only once.

Second, the determined (i.e., most efficient) route may be split into segments each including one or more locations to be visited. Assignments of which agent is to visit the locations within the different segments may be determined using quantum computing system 160. The segments may include the same or different numbers of locations. For example, some agents may travel to multiple locations whereas other agents may only travel to a single location. The route splitting may be performed in accordance with one or more conditions. For instance, the conditions may include the number of segments, and thus the number of agents employed, being minimized and the time required for an agent to travel to each of the locations within their route should be less than or equal to a threshold amount of time (e.g., less than or equal to approximately 8 hours).

Persons of ordinary skill in the art will recognize that each agent may correspond to a human who travels to each prescribed location (e.g., by foot, using a vehicle, and the like) and/or an autonomous agent travel without human intervention or with minimal human intervention (e.g., an unmanned vehicle). The vehicles, whether operated by humans or autonomously, may correspond to land-based vehicles, such as automobiles, trucks, bicycles, motorcycles, vans, and the like. Alternatively, or additionally, other of means of transportation including, but not limited to, trains, airplanes or other aeronautic machines, water-based machines (e.g., boats), drones, robots, and the like, may be used. Furthermore, the techniques described herein can be expanded to include scenarios where multiple modes of transportation are included (e.g., a street network where vehicles and pedestrians travel). As described herein, the term “vehicle” can refer to a car (e.g., sedan, sport utility vehicle, minivan, etc.), truck (e.g., construction vehicles, emergency vehicles, delivery vehicles, etc.), a bicycle or other manually or semi-manually propelled vehicle (e.g., unicycle, tricycle, etc.), boat or other vehicle that travels using waterways, airplane, motorcycle, or other type of vehicle, or combination thereof. Further still, the vehicles described herein can be human-operated, autonomous, or semi-autonomous.

Computing system 102 may include a location subsystem 110, a sequence optimization subsystem 112, a quantum computing interface subsystem 114, an agent optimization subsystem 116, a temporal optimization subsystem 118, or other components. Each of location subsystem 110, sequence optimization subsystem 112, quantum computing interface subsystem 114, agent optimization subsystem 116, and temporal optimization subsystem 118 may be configured to communicate with one another, one or more other devices, systems, servers, etc., using one or more communication networks 150 (e.g., the Internet, an Intranet).

System 100 may also include one or more databases 140 (e.g., location database 142, condition database 144) used to store data for use by one or more components of system 100. This disclosure anticipates the use of one or more of each type of system and component thereof without necessarily deviating from the teachings of this disclosure. Although not illustrated, other intermediary devices (e.g., data stores of a server connected to computing system 102) can also be used.

Location subsystem 110 may be configured to determine a plurality of locations within a geographic region to be visited by an agent. In some embodiments, location subsystem 110 may be configured to receive geographic data comprising a plurality of pairs of longitudes and latitudes describing the plurality of locations. In some examples, the longitude-latitude pairs may be manually input by a user via user device 130 and/or determined via Internet searching and retrieval (e.g., via web-crawling). In some examples, locations may be derived based on an analysis of location sensors integrated in one or more vehicles or other devices.

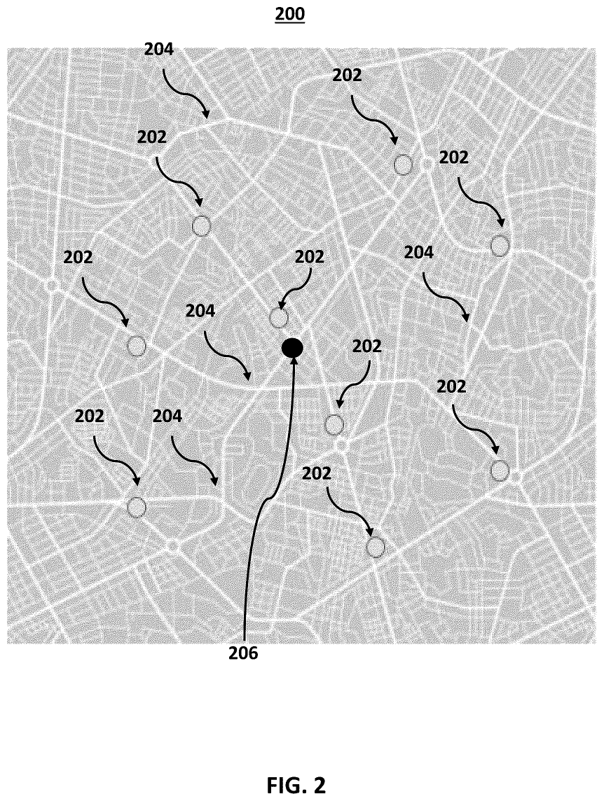

As an example, with reference to FIG. 2, an image 200 depicting locations 202 overlaid on a street network formed of streets 204 may be generated using geographic data received by location subsystem 110. The geographic data may be retrieved from location database 142, sensors coupled to one or more vehicles or users (e.g., wearable devices) and/or input by a user via user device 130. The geographic data may include longitude-latitude pairs indicating locations 202. Locations 202 are to be traveled to by an agent. For example, locations 202 may correspond to residences, businesses, educational institutions, and the like. An agent may travel along streets 204 or other segments to reach each of locations 202. Streets 204 may include local and/or interstate roadways, railways, waterways, air routes, and the like. In some examples, a task may be performed by the agent at a given location 202 (e.g., delivering an item, picking up an item, performing a service, and the like). In one or more examples, a same task may be performed at each of locations 202. In some embodiments, locations 202 may represent nodes of a graph. Streets 204 may represent edges connecting the nodes to one another.

In some embodiments, location subsystem 110 may be configured to calculate a center 206 of the geographic region based on the geographic data. Center 206 may correspond to geographically central location with respect to locations 202. In one or more examples, one of locations 202 may be located at or substantially at center 206. However, in some examples, none of locations 202 may be located at center 206.

### Sequence Objective Function

The two-step approach to solving the agent route optimization problem may begin with identifying a most efficient route for an agent to visit all of locations 202. Returning to FIG. 1, in some embodiments, sequence optimization subsystem 112 may be configured to generate a sequence objective function to identify a sequence with which the plurality of locations are to be visited that minimizes a total distance traveled. Each of the locations (e.g., locations 202 of FIG. 2) will be visited once during the sequence.

In some embodiments, a task may be performed at each location visited. For example, the task may be to deliver one or more items, pick up one or more items, perform a service, and the like. In one or more examples, the task takes a predefined amount of time to complete. For simplicity, it is assumed that the same task will be performed by each agent at every location visited. However, in some embodiments, the task to be performed at one location may differ from the task to be performed at another location. Therefore, the amount of time to complete the various tasks may differ from location to location. In one or more examples, the amount of time it takes for an agent to visit the locations may be based on: (i) the predefined amount of time needed to perform the task as a given location, (ii) a quantity of locations to be visited, and (iii) a distance between each location of the subset of locations. In some embodiments, vehicle location sensors, mobile device sensors, or other geographic positional sensors may be used to learn traffic patterns to identify which routes take more time than other routes. The amount of time may then further be determined based on an estimated traffic along one or more possible routes between locations.

In some embodiments, sequence optimization subsystem 112 may be configured to calculate a plurality of distances. Each distance of the plurality of distances may correspond to a distance between two of the plurality of locations (e.g., location i and location j). In some examples, the distance between location i and location j may represent a shortest distance, however the distance may alternatively correspond to the distance of a route between those two locations that takes the least amount of time to travel. The criteria for which distance is to be selected, assuming multiple routes can be taken between a given pair of locations, may be predefined (e.g., via a user operating user device 130) or learned.

In some embodiments, the distances may be calculated manually given the received geographic data. For example, a distance (e.g., in miles, kilometers, etc.) may be calculated between a longitude and latitude of a first location and a longitude and latitude of a second location. In one or more examples, map software may be employed to determine a route between two locations that takes the least amount of time to travel, has a shortest distance, and/or has the least amount of fees/tolls due. In one or more examples, traffic patterns may be accounted for when computing the routes. For instance, a time of day, current traffic, predicted traffic, road closures, etc., may also be factored into the distance calculations between location pairs.

Sequence optimization subsystem 112 may further be configured to formulate a distance matrix Dᵢⱼ comprising the plurality of distances. The elements of distance matrix Dᵢⱼ correspond to the distance between the i-th location (e.g., node i) and the j-th location (e.g., node j). The sequence objective function may include (e.g., formulated to include) the distance matrix.

In some embodiments, sequence optimization subsystem 112 may generate the sequence objective function by defining a cost function. In one or more examples, the cost function comprises a product of the distance matrix and a binary matrix. Sequence optimization subsystem 112 may be configured to determine a minimum of the cost function, which corresponds to a Hamiltonian cycle H_{dist} having a shortest length for the given nodes (N), where the nodes correspond to the locations to be visited by the agent (e.g., locations 202 of FIG. 2). For example, the Hamiltonian cycle may be represented using Equation 5:

$${H}_{dist} = {\sum }_{i} {\sum }_{j} {D}_{ij} {\sum }_{k} {x}_{i , k} {x}_{j , k + 1} . \qquad Equation 5$$

In Equation 5, distance matrix Dᵢⱼ is considered if the i-th location (e.g., node i) is at position k within the sequence and the j-th location (e.g., node j) is at position k+1 (e.g., immediately after the i-th location). In some embodiments, x_{i,k}x_{j,k+1} represents a binary matrix of locations (e.g., nodes) and positions within the optimized sequence.

The binary matrix may include a plurality of elements (i.e., matrix elements). Each row of the binary matrix corresponds to a location of the plurality of locations (e.g., i-th location) and each column of the binary matrix corresponds to a position within the sequence that the location is to be visited (e.g., k-th position in the sequence). A value of each of the elements can be measured to determine a state. The value may be a first value or a second value. The first value may represent a first state indicating that, for the optimized solution (e.g., sequence solution to the sequence objective function), an agent of the plurality of agents travels to that location at that position within the sequence (e.g., location i is traveled to at position k within the sequence). The second value may represent a second state indicating that, for the optimized solution (e.g., sequence solution to the sequence objective function), the agent does not travel to that location at that position within the sequence (e.g., location i is not traveled to at position k within the sequence). The elements of the binary matrix may then be mapped, respectively, to a plurality of qubits of quantum computing system 160. Thus, the first value corresponds to a first state of a qubit from the plurality of qubits indicating that, for the optimized solution, an agent of the plurality of agents travels to that location at that position within the sequence, and the second value corresponds to a second state of a qubit from the plurality of qubits indicating that, for the optimized solution, the agent does not travel to that location at that position within the sequence. In one or more examples, the cost function may be a constrained quadratic model (CQM). The sequence solution identified by quantum computing system 160 may represent the lowest energy state of the qubits.

In some embodiments, the sequence solution comprising the identified sequence represents the shortest distance to travel to each of the plurality of locations. In one or more examples, the shortest distance may be determined based on a direct distance between locations, or a travel distance—including estimated driving, walking, riding, etc. In some cases, the sequence may further be determined based on the shortest travel time to travel to each of the plurality of locations. For example, one candidate sequence may have a shortest distance but may take longer than another candidate sequence that has a longer distance.

In some embodiments, a set of sequence conditions may be defined or otherwise determined. The set of sequence conditions may include one or more conditions to be satisfied when solving for the sequence solution. For example, the set of sequence conditions may include a first condition and a second condition. The first condition may specify that each location of the plurality of locations is traveled to a single time. The first condition is expressed using Equation 6:

$${\sum }_{j = 0}^{N - 1} {x}_{i , j} = 1 {∀}_{i} = 0 , … , N - 1. \qquad Equation 6$$

In other words, no two agents will travel to a same location and no location will be visited more than once.

The second condition may specify that each location of the plurality of locations occupies a single position within the sequence. For example, if there are three locations: A, B, and C, the sequence cannot include multiples of any of locations A, B, or C (e.g., the sequence could be A→B→C, A→C→B, B→C→A, B→A→C, C→A→B, C→B→A, but cannot be A→B→A→C, or another permutation where location A, B, or C occurs multiple times). The second condition can be expressed using Equation 7:

$${\sum }_{j = 0}^{N - 1} {x}_{i , j} = 1 {∀}_{j} = 0 , … , N - 1. \qquad Equation 7$$

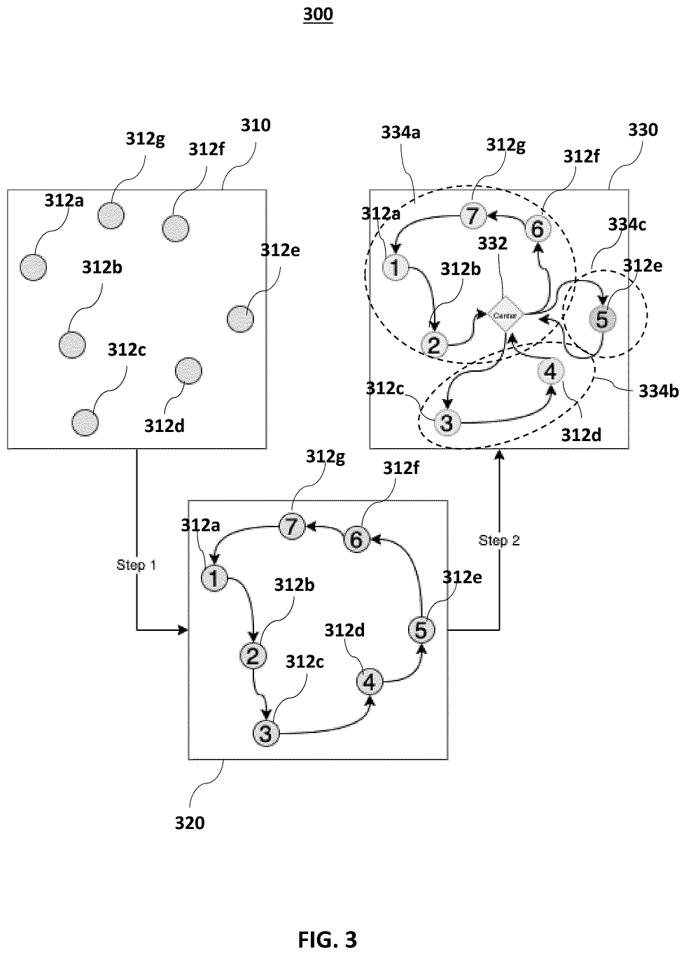

Quantum computing interface subsystem 114 may be configured to input the sequence objective function and a set of sequence conditions into quantum computing system 160 to determine a sequence solution comprising the sequence. The sequence solution may represent an optimized route for an agent to take to travel to each location in least amount of time and/or with a shortest distance. As an example, with reference to FIG. 3, a process 300 for determining an optimized quantity of agents and routes for the agents using a two-step process is illustrated. In process 300, geographic data 310 may be obtained. Geographic data 310 may include seven (7) locations 312a-312g that are to be visited. The sequence solution may represent the optimized route for an agent to take to travel to each of locations 312a-312g, as described above. In other words, the sequence solution indicates the order with which each of locations 312a-312g is to be visited. For example, the optimized route (e.g., the sequence with which locations 312a-312g are to be traveled to so as to minimize an amount of time needed to travel to those locations and/or to minimize a total distance traveled) may be represented via Table 1:

TABLE 1

| Position | Location |
|---|---|
| 1 | 312a |
| 2 | 312b |
| 3 | 312c |
| 4 | 312d |
| 5 | 312e |
| 6 | 312f |
| 7 | 312g |

Other sequences may be possible; however, these may account for a greater travel time, a greater distance to be traveled, or may be less optimal for other reasons. For example, instead of location 312b being at position “2” (i.e., the second location visited in the sequence) and location 312f being at position “6” (i.e., the sixth location visited in the sequence), location 312f could be at position “2” and location 312b could be at position “6.” However, this route may encompass a greater travel time and/or distance, as an agent would need to travel from location 312a to location 312f, and then to location 312c, which intuitively is longer (temporally and physically) than traveling from locations 312a to location 312b and then to location 312c.

In some embodiments, quantum computing system 160 may include a plurality of qubits. A quantity of qubits to be used by quantum computing system 160 to determine the optimized solution may be based on a quantity of locations of the plurality of locations. In some examples, the quantity of qubits of quantum computing system 160 may be 1,000 or more qubits, 10,000 or more qubits, 20,000 or more qubits, 50,000 or more qubits, or 100,000 or more qubits, or other quantities of qubits. In some embodiments, quantum computing interface subsystem 114 may be configured to map elements of the binary matrix to qubits of quantum computing system 160. In one or more examples, each element of the binary matrix (e.g., xᵢⱼ) may be a binary variable. Similarly, each qubit may de-cohere to a first state (e.g., spin up) or a second state (e.g., spin down). The elements of the binary matrix may be mapped to qubits of quantum computing system 160. The sequence solution identified by quantum computing system 160 may, therefore, represent the lowest energy state of the qubits.

After the sequence solution has been obtained, the second step of the two-step approach may be performed. The second step involves determining an optimum number of agents (e.g., a minimum number of agents) needed to visit the locations (e.g., locations 312a-312g of FIG. 3), which locations each agent is to visit, and an order with which each agent is to visit their respective locations. The second step comprises solving, using quantum computing system 160, two objective functions: an agent quantity objective function and a temporal duration objective function.

### Agent Quantity Objective Function

Returning to FIG. 1, agent optimization subsystem 116 may be configured to generate an agent quantity objective function to identify a minimum quantity of agents to visit the plurality of locations based on the sequence solution. In one or more examples, each of the agents may be assigned to visit a subset of locations of the plurality of locations.

In some embodiments, agent optimization subsystem 116 may be configured to define a first cost function comprising a binary matrix, X. The binary matrix comprises a plurality of elements x_{i,j}. For instance, each row of the binary matrix corresponds an agent of a plurality of agents (e.g., an i-th agent) and each column of the binary matrix corresponds to a position within the sequence (e.g., a j-th position). Furthermore, each of the elements x_{i,j} can have (i) a first value corresponding to a first state indicating that, for the optimized solution, the agent travels to the location at the position (e.g., the i-th agent at the j-th position) or (ii) a second value corresponding to a second state indicating that the agent does not travel to the location at the position. In some embodiments, elements x_{i,j} of the binary matrix may be mapped to qubits of quantum computing system 160. For example, the first value may correspond to a first state of the qubit and the second value may correspond to a second state of the qubit. In some embodiments, the agent quantity objective function comprises the binary matrix, which may be summed across the plurality of agents to determine whether each row includes at least one element having the first state. As an example, the agent optimization objective function can be represented using Equation 8:

$${N}_{a} = {\sum }_{j = 0}^{N - 1} ( {x}_{i , 0} ⋁ {x}_{i , 1} ⋁ {x}_{i , 2} … ⋁ {x}_{i , N - 1} ) . \qquad Equation 8$$

In Equation 8, Nₐ represents the optimum number of agents, x_{i,j}=1 if the i-th agent visits the j-th location (e.g., position j in the sequence identified from the sequence solution), and x_{i,j}=0 otherwise. Equation 8 serves as a check to determine whether a given row has at least one “true” value. For example, a row of the binary matrix including no true values (e.g., all elements of the matrix for that row are 0) indicates that one fewer agent is needed.

In some embodiments, if there are N total locations to be traveled to, then a maximum number of agents that could be used to travel to each of the locations may be N agents. This solution may reduce the travel time to an absolute minimum, but uses the maximum number of agents. The minimum number of agents that could be used to travel to the locations would be one agent, however this solution may maximize the travel time for the agent. For example, with reference again to FIG. 3, if there are seven total locations (e.g., locations 312a-312g), then at most seven agents could be used to travel to the locations. In this scenario, each agent would travel to one of locations 312a-312g, with no agent traveling to a location traveled to by another agent, and no location being visited more than once. At minimum, a single agent could be used, which would resolve to that agent traveling along the route identified from the first step of the two-step approach. Thus, to begin with, the binary matrix may include seven rows and seven columns, with each row corresponding to one possible agent. A row including only zeros indicates that that agent is not needed when determining the minimum number of agents. In the example of FIG. 3, to travel to locations 312a-312g most efficiently, only three agents may be needed, as detailed below.

### Temporal Duration Objective Function

Returning again to FIG. 1, temporal optimization subsystem 118 may be configured to generate a temporal duration objective function to identify, for each of the agents, a subset of locations from the plurality of locations to be visited by the agent. In one or more examples, the subset of locations may be assigned to each of the agents so as to minimize an amount of time for the agent to visit each location of the subset of locations. As an example, with reference again to FIG. 3, the temporal duration objective function's solution may indicate that one agent is to travel to locations 312a, 312b, 312f, and 312g, another agent is to travel to locations 312c and 312d, and another agent is to travel to location 312e.

In some embodiments, the temporal duration objective function may comprise the binary matrix being summed across the plurality of agents. The summation may determine: (i) a first amount of time for each of the plurality of agents to travel from a center 332 of the geographic region to a given location of the plurality of locations, (ii) a second amount of time for each of the plurality of agents to travel from an immediately previous location to the given location, (iii) a third amount of time for each of the plurality of agents to travel from the immediately previous location to center 332. For example, the temporal duration objective function may be represented using Equation 9:

$${N}_{t} = {\sum }_{t}^{N - 1} ( {N}_{i}^{C \to j} + {N}_{i}^{j - 1 \to j} + {N}_{i}^{j - 1 \to C} ) . \qquad Equation 9$$

In Equation 9, Nₜ represents a total (minimum) time to travel to each of the locations (e.g., locations 312a-312g). The temporal duration objective function comprises one or more components. For example, the temporal duration objective function may include a first component

$${N}_{i}^{C \to j} ,$$

a second component

$${N}_{i}^{j - 1 \to j} ,$$

and a third component

$${N}_{i}^{j - 1 \to C} .$$

In one or more examples, generating the temporal duration objective function comprises combining the first component

$${N}_{i}^{C \to j} ,$$

the second component

$${N}_{i}^{j - 1 \to j} ,$$

and the third component

$${N}_{i}^{j - 1 \to C}$$

for each of the agents.

The first component

$${N}_{i}^{C \to j}$$

may be used to determine a first amount of time based on the binary matrix and a first distance matrix D_{C,j} comprising distances from the center to each of the plurality of locations. For example, first component

$${N}_{i}^{C \to j}$$

can be represented using Equation 10:

$${N}_{i}^{C \to j} = {\sum }_{t}^{N - 1} {D}_{C , j} {x}_{i , j} ( 1 - {x}_{i , j - 1} ) . \qquad Equation 10$$

In Equation 10, first matrix D_{C,j} includes elements representing a distance from center 332 to the j-th location. In some embodiments, first matrix D_{C,j} may be computed in advance using location subsystem 110, or via another component of system 100 of FIG. 1.

The second component

$${N}_{i}^{j - 1 \to j}$$

may be used to determine a second amount of time based on the binary matrix and a second distance matrix D_{j-1,j} comprising distances from the immediately previous location (e.g., the (j−1)-th location) to the given location (e.g., the j-th location). For example, second component

$${N}_{i}^{j - 1 \to j}$$

can be represented using Equation 11:

$${N}_{i}^{j - 1 \to j} = {\sum }_{j}^{N - 1} {D}_{j - 1 , j} {x}_{i , j - 1} {x}_{i , j} ) . \qquad Equation 11$$

In Equation 11, second distance matrix D_{j-1,j} includes elements representing a distance from the (j−1)-th location to the j-th location. In some embodiments, second distance matrix D_{j-1,j} may be computed in advance using location subsystem 110, or via another component of system 100 of FIG. 1. In one or more examples, second distance matrix D_{j-1,j} may be the same, or similar to, distance matrix Dᵢⱼ of Equation 5.

The third component

$${N}_{i}^{j - 1 \to C}$$

may be used to determine a third amount of time based on the binary matrix and a third distance matrix D_{j-1,C} comprising distances from the immediately previous location (e.g., the (j−1)-th location) to center 322. For example, third component

$${N}_{i}^{j - 1 \to C}$$

can be represented using Equation 12:

$${N}_{i}^{j - 1 \to C} = {\sum }_{j}^{N - 1} {D}_{j - 1 , C} {x}_{i , j - 1} ( 1 - {x}_{i , j} ) . \qquad Equation 12$$

In Equation 12, third distance matrix D_{j-1,C} includes elements representing a distance from the (j−1)-th location to center 322. In some embodiments, third distance matrix D_{j-1,C} may be computed in advance using location subsystem 110, or via another component of system 100 of FIG. 1.

In some embodiments, the agent quantity objective function Nₐ and the temporal duration objective function Nₜ each include a matrix comprising rows representing a plurality of candidate agents and columns representing candidate locations to be visited by a corresponding agent. Agent optimization subsystem 116 and/or temporal optimization subsystem 118 may be configured to remove any agents determined to not travel to at least one of the plurality of locations from the plurality of candidate agents, as mentioned above. In one or more examples, the minimum quantity of agents may be determined from the plurality of candidate agents.

In some embodiments, the set of agent-quantity conditions may include one or more conditions. Each condition may represent a constraint for quantum computing system 160 to implement when solving the agent quantity objective function and the temporal duration optimization function. For example, the set of agent-quantity conditions may include a first condition specifying that the amount of time for the agent to visit each location of the subset of locations should be less than or equal to a threshold amount of time, t_{threshold} (e.g., 4 hours, 6 hours, 8 hours, 12 hours, 24 hours, etc.). For example, the first condition may be expressed using Equation 13:

$${N}_{i}^{C \to j} + {N}_{i}^{j - 1 \to j} + {N}_{i}^{j - 1 \to C} + {\sum }_{j}^{N - 1} {x}_{i , j} \leq {t}_{threshold} ∀ i = 0 , … , N - 1. \qquad Eqution 13$$

The set of agent-quantity conditions may also include a second condition specifying that each of the plurality of locations (e.g., locations 312a-312g) is included within the sequence with which the plurality of locations are to be visited. In other words, each of locations 312a-312g will be visited by an agent, albeit by different agents. As an example, the second condition may be expressed using Equation 14:

$${\sum }_{j}^{N - 1} ( {x}_{i , j} + {x}_{i , j - 1} - 2 {x}_{i , j} {x}_{i , j - 1} ) \leq 2 ∀ i = 0 , … , N - 1. \qquad Equation 14$$

The set of agent-quantity conditions may still further include a third condition specifying that each location of the plurality of locations is visited by only one agent. For example, the third condition may be expressed using Equation 15:

$${\sum }_{j = 0}^{N - 1} {x}_{i , j} = 1 ∀ i = 0 , … , N - 1. \qquad Equation 15$$

In other words, no two agents are to visit a same location and each position in the sequence of locations to be visited is assigned to a single agent.

Quantum computing interface subsystem 114 may further be configured to input the agent quantity objective function, the temporal duration objective function, and the set of agent-quantity conditions to quantum computing system 160 to determine an optimized solution comprising the minimum quantity of agents, the subsets of locations to be traveled to by each of the agents in the minimized amount of time, and an order with which the agent is to travel to each location within a corresponding subset of locations. For example, as seen by FIG. 3, the optimized solution produced by quantum computing system 160 may be graphically represented via image 330.

In image 330, each of locations 312a-312g is assigned to one of three routes: a first route 334a, a second route 334b, and a third route 334c. First route 334a may be assigned to a first agent. First route 334a may include a first subset of locations including locations 312a, 312b, 312f, and 312g. In the optimized solution, the first agent may travel first to location 312f from center 322. After traveling to location 312f, first route 334a may include the first agent traveling to locations 312g, 312a, and 312b in this order. In some examples, a last step of first route 334a may include the first agent returning to center 332 after traveling to location 312b. Second route 334b may be assigned to a second agent. Second route 334b may include a second subset of locations including locations 312c, 312d. In the optimized solution, the second agent may travel to location 312c from center 332, followed by location 312d. In some examples, a last step of second route 334b may include the second agent returning to center 332 after traveling to location 312d. Third route 334c may be assigned to a third agent. Third route 334c may include a third subset of locations including location 312e. In the optimized solution, the third agent may travel to location 312e from center 332, after which the third agent may return to center 332.

Thus, the optimized solution output from quantum computing system 160 may include an indication of the number of agents to include, which locations are to be traveled to by those agents, and the order with which those agents are to travel to their respective locations. In the example of FIG. 3, the optimized solution may indicate that, based on the determined sequence (e.g., from 320), three agents are needed to travel to locations 312a-312g and the routes to be taken by those three agents to adhere to the agent-quantity conditions.

In some embodiments, the optimized solution may not satisfy each of the conditions. For example, with reference again to FIG. 3, the first agent traveling along first route 334a may take slightly longer than the threshold amount of time specified by the first condition. For example, the threshold amount of time may be 8 hours, and the amount of time for the first agent to travel along first route 334a may take (estimated) approximately 9 hours. The optimized solution does not require that the conditions strictly be satisfied because that solution may not physically possible. However, the optimized solution does represent the optimal parameters for solving the agent route optimization problem that satisfies the conditions as best as possible.

In some embodiments, the optimized solution may be used to generate routing instructions. The routing instructions may indicate the locations and routes (e.g., the sequence of locations) to be visited by each agent. For example, the routing instructions may include addresses of each location within an agent's subset of locations to be visited, the streets and/or pathways to be traveled to reach each location, traffic information associated with each route, or other information, or combinations thereof. In some embodiments, the routing instructions may be used to generate graphical user interfaces to display step-by-step directions for an agent to travel from one location to another. The routing instructions may be stored in location database 142. In some examples, the routing instructions may be disseminated to each agent's user device. In one or more examples, real-time agent location data may be tracked via sensors associated the agent (e.g., sensors integrated within an agent's user device 130, sensors integrated within a smart vehicle operated by the agent, sensors of unmanned vehicle operating as the agent, etc.). The tracked locations may further be used to refine the routes (e.g., using machine learning models).

In some embodiments, quantum computing system 160 may include a plurality of qubits. A quantity of qubit to be used by quantum computing system 160 to determine the optimized solution may be based on a quantity of locations of the plurality of locations. In some examples, the quantity of qubits of quantum computing system 160 may be 1,000 or more qubits, 10,000 or more qubits, 20,000 or more qubits, 50,000 or more qubits, or 100,000 or more qubits, or other quantities of qubits. In some embodiments, quantum computing interface subsystem 114 may be configured to map variables from an objective function to qubits of quantum computing system 160. For example, elements of the binary matrix used to define the cost functions of the agent quantity objective function and the temporal duration optimization function may be mapped to qubits of quantum computing system 160.

In some embodiments, the agent quantity objective function and the temporal duration objective function are solved, via quantum computing system 160, together. For example, both may be solved contemporaneously in accordance with conditions associated with their objective functions. This may be a result of the agent quantity objective function and the temporal duration objective function including the binary matrix x_{i,j}, as illustrated by Equations 8 and 9.

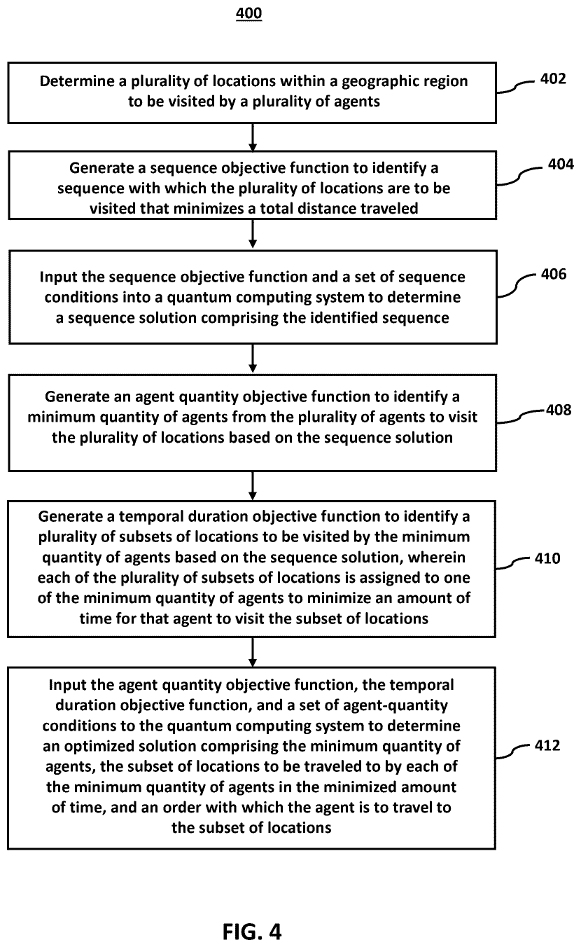

FIG. 4 illustrates a flowchart of an example method 400 for determining an optimized quantity of agents and routes for the agents using quantum computing, in accordance with various embodiments. In some embodiments, method 400 may be executed utilizing one or more processing devices (e.g., computing system 600 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other processing device(s) that may be suitable for processing genomics data, proteomics data, metabolomics data, metagenomics data, transcriptomics data, or other omics data and making one or more decisions based thereon), software (e.g., instructions running/executing on one or more processors), firmware (e.g., microcode), or some combination thereof.

In some embodiments, method 400 may begin at step 402. At step 402, a plurality of locations within a geographic region to be visited by an agent may be determined. For example, geographic data comprising longitudes and latitudes of a collection of locations that are to be visited (e.g., to deliver an item, to pick up an item, to perform a task or provide a service, etc.) may be received from user device 130 and/or location database 142. In some embodiments, step 402 may be performed by a subsystem that is the same or similar to location subsystem 110.

At step 404, a sequence objective function may be generated to identify a sequence with which the plurality of locations are to be visited to minimize a total distance traveled. In some embodiments, a plurality of distances may be calculated each corresponding to a distance between two of the plurality of locations (e.g., location i and location j). A distance matrix Dᵢⱼ may be formulated comprising the plurality of distances as matrix elements The sequence objective function may include (e.g., formulated to include) the distance matrix. The sequence objective may be defined using a cost function including a product of the distance matrix and a binary matrix, as illustrated in Equation 5. The binary matrix may include a plurality of elements (i.e., matrix elements) corresponding to a location of the plurality of locations (e.g., i-th location) and a position within the sequence that the location is to be visited (e.g., k-th position in the sequence). In some embodiments, step 404 may be performed by a subsystem that is the same or similar to sequence optimization subsystem 112.

At step 406, the sequence objective function may be input, along with a set of sequence conditions, into a quantum computing system to determine a sequence solution comprising the sequence. The set of sequence conditions may include one or more conditions to be satisfied when quantum computing system 160 solving for the sequence solution. For example, the set of sequence conditions may include a first condition and a second condition. The first condition may specify that each location of the plurality of locations is traveled to a single time, as represented by Equation 6. In other words, no two agents will travel to a same location, and each agent will travel to a same location more than one time. The second condition may specify that each location of the plurality of locations occupies a single position within the sequence. The sequence solution may indicate a sequence or order with which the locations are to be visited. This sequence of the locations may represent a most efficient route for an agent to take to visit each location. In some embodiments, step 406 may be performed by a subsystem that is the same or similar to quantum computing interface subsystem 114.

At step 408, an agent quantity objective function may be generated to identify a minimum quantity of agents to visit the plurality of locations. In one or more examples, each of the agents are assigned to visit a subset of locations of the plurality of locations. In some embodiments, a first cost function comprising a binary matrix, X, may be defined. Each row of the binary matrix may correspond to an agent of a plurality of agents (e.g., an i-th agent) and each column of the binary matrix may correspond to a position within the sequence (e.g., a j-th position). The agent quantity objective function comprises the binary matrix, which may be summed across the plurality of agents to determine whether each row includes at least one element having the first state, as illustrated by FIG. 4. In some embodiments, step 408 may be performed by a subsystem that is the same or similar to agent optimization subsystem 116.

At step 410, a temporal duration objective function may be generated to identify, for each of the agents, a subset of locations from the plurality of locations to visited by the agent. In one or more examples, the subset of locations assigned to each of the agents minimizes an amount of time for the agent to visit each location of the subset of locations. In some embodiments, the temporal duration objective function may comprise the binary matrix being summed across the plurality of agents. For example, the temporal duration objective function may be represented using Equation 9. The temporal duration objective function may include one or more components. For example, the temporal duration objective function may include a first component

$${N}_{i}^{C \to j} ,$$

a second component

$${N}_{i}^{j - 1 \to j} ,$$

and a third component

$${N}_{i}^{j - 1 \to C} ,$$

which may be combined. The first component

$${N}_{i}^{C \to j}$$

may be used to determine a first amount of time based on the binary matrix and a first distance matrix D_{C,j} comprising distances from the center to each of the plurality of locations, as illustrated by Equation 10. The second component

$${N}_{i}^{j - 1 \to j}$$

may be used to determine a second amount of time based on the binary matrix and a second distance matrix D_{j-1,j} comprising distances from the immediately previous location (e.g., the (j−1)-th location) to the given location (e.g., the j-th location), as illustrated by Equation 11. The third component

$${N}_{i}^{j - 1 \to C}$$

may be used to determine a third amount of time based on the binary matrix and a third distance matrix D_{j-1,C} comprising distances from the immediately previous location (e.g., the (j−1)-th location) to center 322, as illustrated by Equation 12. In some embodiments, step 410 may be performed by a subsystem that is the same or similar to temporal optimization subsystem 118.

At step 412, the agent quantity objective function, the temporal duration objective function, and a set of agent-quantity conditions may be input to quantum computing system 160 to determine an optimized solution. The optimized solution may comprise the minimum quantity of agents, the subsets of locations to be traveled to by each of the agents in the minimized amount of time, and an order with which the agent is to travel to each location within a corresponding subset of locations. For example, as seen by FIG. 3, the optimized solution produced by quantum computing system 160 may be graphically represented via image 330. The optimized solution output from quantum computing system 160 may include an indication of the number of agents to include, which locations are to be traveled to by those agents, and the order with which those agents are to travel to their respective locations. In the example of FIG. 3, the optimized solution may indicate that, based on the determined sequence (e.g., from 320), three agents are needed to travel to locations 312a-312g and the routes to be taken by those three agents to adhere to the agent-quantity conditions. In some embodiments, step 412 may be performed by a subsystem that is the same or similar to quantum computing interface subsystem 114.

Number of Locations is Greater than Number of Qubits

In some embodiments, the number of variables needed to solve for the N locations may be 2N². For example, the first step—determining the sequence solution to the sequence optimization function—may use N² variables, and similarly the second step—determining the minimum number of agents needed to visit each of the locations in the most efficient manner—may also use N² variables. The total number of conditions needed to solve the agent route optimization problem may be 5N, with 2N coming from the first step and 3N coming from the second step. Additional conditions may also be included.

In some embodiments, the total number of locations for which an optimized route and optimum quantity of agents are determined may be restricted by the number of qubits available for processing via quantum computing system 160. For example, because the total number of variables needed is 2N², the number of locations that can be processed during a given run of quantum computing system 160 may be determined using Equation 16:

$$Number of locations \leq \sqrt{\frac{Number of qubits}{2}} . \qquad Equation 16$$

As an example, using Equation 16, if quantum computing system 160 includes 20,000 qubits, then the total number of locations that can be analyzed during a given execution of the two-step process may be limited to 100 locations. If quantum computing system 160 includes 2,000 qubits, then the total number of locations that can be analyzed during a given execution of the two-step process may be limited to 10 locations. Persons of ordinary skill in the art will recognize that the aforementioned examples are illustrative, and different quantum computing systems may be configured with different quantities of qubits. If the number of locations to be analyzed is greater than

$$\sqrt{\frac{Number of qubits}{2}} ,$$

Number of qubits, the geographic data may be split into different sup-regions, which may then be processed serially.

Returning to FIG. 1, location subsystem 110 may be configured to receive geographic data indicating a collections of locations within a geographic region that are to be visited by an agent. For example, as seen in FIG. 2, geographic data including locations 202 may be retrieved from location database 142 and/or input by a user via user device 130. The geographic data may include longitude-latitude pairs indicating locations 202 that are to be traveled to by an agent. For example, locations 202 may correspond to residences, businesses, educational institutions, and the like. An agent may travel along streets 204 or other segments to reach each of locations 202. Streets 204 may include local and/or interstate roadways, railways, waterways, air routes, and the like. In some examples, a task may be performed by the agent at a given location 202 (e.g., delivering an item, picking up an item, performing a service, and the like). In one or more examples, a same task may be performed at each of locations 202. In some embodiments, locations 202 may represent nodes of a graph. Streets 204 may represent edges connecting the nodes to one another.

In some embodiments, location subsystem 110 may be configured to calculate a center 206 of the geographic region based on the geographic data. Center 206 may correspond to geographically central location with respect to locations 202. In one or more examples, one of locations 202 may be located at or substantially at center 206. However, in some examples, none of locations 202 may be located at center 206.

In some embodiments, location subsystem 110 may be configured to determine whether a quantity of locations included within the collection of locations fails to satisfy a threshold condition. In one or more examples, the threshold location quantity may be determined based on a quantity of qubits implemented by quantum computing system 160. In some embodiments, quantum computing system 160 may include a plurality of qubits. For example, quantum computing system 160 may include 1,000 or more qubits, 10,000 or more qubits, 20,000 or more qubits, 50,000 or more qubits, or 100,000 or more qubits, or other quantities of qubits.

In some embodiments, the threshold location quantity condition being satisfies comprises the quantity of locations being less than or equal to a threshold quantity of locations. The threshold quantity of locations may be determined based on the quantity of qubits implemented by quantum computing system 160. For example, as determined via Equation 16, if quantum computing system 160 includes 20,000 qubits, then the total number of locations that can be analyzed during a given execution of the two-step process may be limited to 100 locations (or fewer). The threshold location quantity condition failing to be satisfied comprises the quantity of location being greater than the threshold quantity of locations.

In some embodiments, if location subsystem 110 determines that the quantity of locations in the collection of locations fails to satisfy the threshold location quantity condition, then location subsystem 110 may be configured to split the collection of locations into a plurality of sets of locations. In one or more examples, a quantity of locations included within each of the plurality of sets of locations satisfies the threshold location quantity condition. In some examples, each set of locations may include a same or similar quantity of locations. For example, if there are 1,000 locations included in the collection of locations, then location subsystem 110 may split the 1,000 locations into 10 sets each including 100 locations. In this example, if quantum computing system 160 includes 20,000 qubits, then each set of 100 locations would satisfy the threshold location quantity condition. Persons of ordinary skill in the art will recognize that some sets of locations may include fewer locations than the other sets. For example, if there are 1,020 locations and quantum computing system 160 includes 20,000 qubits, then location subsystem 110 may split the collection of 1,020 locations into 10 sets of 100 locations and 1 set of 20 locations, however other distributions may be used.

Upon obtaining the plurality of sets of locations each satisfying the threshold location quantity condition, each one may be analyzed using the two-step process to solving the agent route optimization problem.

In some embodiments, sequence optimization subsystem 112 may be configured to generate a sequence objective function to identify a sequence with which the each set of locations of the plurality of locations are to be visited that minimizes a total distance traveled. Each agent may perform a task at each location within the set of locations. In one or more examples, the amount of time for the agent to visit each location of the subset of locations may be based on: (i) a predefined amount of time to perform the task, (ii) a quantity of locations included by the subset of locations, and (iii) a distance between each location of the subset of locations.

In some embodiments, sequence optimization subsystem 112 may be configured to calculate a plurality of sets of distances. Within a given set of distances, each distance may correspond to a distance between two locations from the set of locations (e.g., location i and location j). In some examples, the distance between location i and location j may represent a shortest distance, however the distance may alternatively correspond to the distance of a route between those two locations that takes the least amount of time to travel. Sequence optimization subsystem 112 may further be configured to formulate a distance matrix Dᵢⱼ comprising the set of distances. The elements of distance matrix Dᵢⱼ correspond to the distance between the i-th location (e.g., node i) and the j-th location (e.g., node j). The sequence objective function may include (e.g., formulated to include) the distance matrix. In some embodiments, a plurality of distance matrices Dᵢⱼ^{l}, where l refers to a l-th set of locations of the plurality of locations.

In some embodiments, sequence optimization subsystem 112 may generate the sequence objective function by defining a cost function. In some embodiments, a plurality of sequence objective functions may be generated, each corresponding to a set of locations of the plurality of sets of locations. In one or more examples, each cost function comprises a product of the distance matrix Dᵢⱼ^{l} and a binary matrix. Sequence optimization subsystem 112 may be configured to determine a minimum of the cost function, which corresponds to an l-th Hamiltonian cycle H_{dist} having a shortest length for the given nodes (N), where the nodes correspond to the locations to be visited by the agent within the l-th set of locations.

In some embodiments, quantum computing interface subsystem 114 may be configured to input each sequence objective function and a set of sequence conditions to a quantum computing system to determine a sequence solution comprising the sequence. In one or more examples, a sequence solution may be determined for each of the l sequence objective functions. The sequence solution comprising the sequence may represent the shortest distance to travel to each location within the set of locations. In some embodiments, a set of sequence conditions may be defined or otherwise determined. The set of sequence conditions may include one or more conditions to be satisfied when solving for each sequence solution. For example, the set of sequence conditions may include a first condition and a second condition. The first condition may specify that each location of the plurality of locations is traveled to a single time, as illustrated by Equation 6. The second condition may specify that each location of the plurality of locations occupies a single position within the sequence, as illustrated by Equation 7.

Quantum computing interface subsystem 114 may be configured to input each sequence objective function and a set of sequence conditions into quantum computing system 160 to determine a sequence solution comprising the sequence. The sequence solution may represent an optimized route for an agent to take to travel to each location within the set of locations in least amount of time and/or with a shortest distance. Quantum computing system 160 may include a plurality of qubits used to determine the optimized solution. In some embodiments, quantum computing interface subsystem 114 may be configured to map elements of the binary matrix (of each sequence objective function) to qubits of quantum computing system 160. In one or more examples, each element of the binary matrix (e.g., xᵢⱼ) may be a binary variable. Similarly, each qubit may de-cohere to a first state (e.g., spin up) or a second state (e.g., spin down). The elements of the binary matrix may be mapped to qubits of quantum computing system 160. The sequence solution identified by quantum computing system 160 may, therefore, represent the lowest energy state of the qubits.

In some embodiments, agent optimization subsystem 116 may be configured to generate an agent quantity objective function to identify a minimum quantity of agents to visit the set of locations. The agent quantity objective function may be generated for each set of locations of the plurality of sets of locations. Thus, if there are l sets of locations, then l agent quantity objective functions may be generated. In one or more examples, each of the agents may be assigned to visit a subset of locations of the set of locations.

In some embodiments, for each set of locations of the plurality of sets of locations, agent optimization subsystem 116 may be configured to define a first cost function comprising a binary matrix, X. The binary matrix comprises a plurality of elements x_{i,j}. For instance, each row of the binary matrix corresponds an agent of a plurality of agents (e.g., an i-th agent) and each column of the binary matrix corresponds to a position within the sequence (e.g., a j-th position). Furthermore, each of the elements x_{i,j} can have (i) a first state indicating that, for the optimized solution, the agent travels to the location at the position (e.g., the i-th agent at the j-th position) or (ii) a second state indicating that the agent does not travel to the location at the position. The binary matrix, which may be summed across the plurality of agents to determine whether each row includes at least one element having the first state, as illustrated by Equation 8.

In some embodiments, temporal optimization subsystem 118 may be configured to generate a temporal duration objective function to identify, for each of the agents associated with each respective set of locations of the plurality of locations, a subset of locations from the set of locations to be visited by the agent. In one or more examples, the subset of locations may be assigned to each of the agents so as to minimize an amount of time for the agent to visit each location of the subset of locations. The temporal duration objective function may be generated for each set of locations of the plurality of sets of locations. Thus, if there are l sets of locations, then l temporal duration objective functions may be generated.

In some embodiments, the temporal duration objective function may comprise the binary matrix being summed across the plurality of agents. The summation may determine: (i) a first amount of time for each of the plurality of agents to travel from a center of the geographic region to a given location of the plurality of locations, (ii) a second amount of time for each of the plurality of agents to travel from an immediately previous location to the given location, (iii) a third amount of time for each of the plurality of agents to travel from the immediately previous location to the center, as illustrated by Equation 9. Each temporal duration objective function comprises one or more components. For example, the temporal duration objective function may include a first component

$${N}_{i}^{C \to j} ,$$

a second component

$${N}_{i}^{j - 1 \to j}$$

and a third component

$${N}_{i}^{j - 1 \to C} ,$$

as illustrated by Equations 10-12. In one or more examples, generating the temporal duration objective function comprises combining the first component

$${N}_{i}^{C \to j} ,$$

the second component

$${N}_{i}^{j - 1 \to j} ,$$

and the third component

$${N}_{i}^{j - 1 \to C}$$

for each of the agents.

In some embodiments, the agent quantity objective function Nₐ and the temporal duration objective function Nₜ each include a matrix comprising rows representing a plurality of candidate agents and columns representing candidate locations to be visited by a corresponding agent. Agent optimization subsystem 116 and/or temporal optimization subsystem 118 may be configured to remove any agents determined to not travel to at least one of the set of locations from the plurality of candidate agents, as mentioned above. In one or more examples, the minimum quantity of agents may be determined from the plurality of candidate agents.

In some embodiments, the set of agent-quantity conditions may include one or more conditions. Each condition may represent a constraint for quantum computing system 160 to implement when solving each of the l agent quantity objective functions and each of the l temporal duration optimization functions. For example, the set of agent-quantity conditions may include a first condition specifying that the amount of time for the agent to visit each location of the subset of locations should be less than or equal to a threshold amount of time, t_{threshold} (e.g., 4 hours, 6 hours, 8 hours, 12 hours, 24 hours, etc.), as illustrated by Equation 13. The set of agent-quantity conditions may also include a second condition specifying that each of the set of locations is included within the sequence with which the set of locations are to be visited, as illustrated by Equation 14. The set of agent-quantity conditions may still further include a third condition specifying that each location of the set of locations is visited by only one agent, as illustrated by Equation 15.

Quantum computing interface subsystem 114 may further be configured to input the agent quantity objective function, the temporal duration objective function, and the set of agent-quantity conditions to quantum computing system 160 to determine an optimized solution comprising the minimum quantity of agents, the subsets of locations to be traveled to by each of the agents in the minimized amount of time, and an order with which the agent is to travel to each location within a corresponding subset of locations. Thus, the optimized solution output from quantum computing system 160 may include an indication of the number of agents to include, which locations are to be traveled to by those agents, and the order with which those agents are to travel to their respective locations. In some embodiments, the optimized solution may not satisfy each of the conditions. However, the optimized solution does represent the optimal parameters for solving the agent route optimization problem that satisfies the conditions as best as possible.

In some embodiments, quantum computing system 160 may include a plurality of qubits. A quantity of qubit to be used by quantum computing system 160 to determine the optimized solution may be based on a quantity of locations of the plurality of locations. In some examples, the quantity of qubits of quantum computing system 160 may be 1,000 or more qubits, 10,000 or more qubits, 20,000 or more qubits, 50,000 or more qubits, or 100,000 or more qubits, or other quantities of qubits. In some embodiments, quantum computing interface subsystem 114 may be configured to map variables from an objective function to qubits of quantum computing system 160. For example, elements of the binary matrix used to define the cost functions of the agent quantity objective function and the temporal duration optimization function may be mapped to qubits of quantum computing system 160.

In some embodiments, each of the l agent quantity objective functions and each of the l temporal duration objective functions may be solved, via quantum computing system 160, together. For example, for a first set of locations of the plurality of sets of locations, a first agent quantity objective function and a first temporal duration objective function may be solved via quantum computing system 160 contemporaneously. After a first optimized solution is determined based on the configurations of first agent quantity objective function and a first temporal duration objective function and the set of conditions, a second agent quantity objective function and a second temporal duration objective function corresponding to a second set of locations of the plurality of sets of locations may be input to quantum computing system 160 to obtain a second optimized solution.

In some embodiments, quantum computing interface subsystem 114 may be configured to generate a global solution based on the optimized solution determined for each of the plurality of sets of locations. For example, the l agent quantity objective functions and each of the l temporal duration objective functions may result in l optimized solutions being obtained, respectively corresponding to the l sets of locations. The l optimized solutions may be combined to obtain the global solution. Thus, the global solution may indicate a minimum quantity of agents needed to travel to each of the collection of locations, which of these agents are to travel to each of the locations, and the order with which those agents are to travel to those locations.

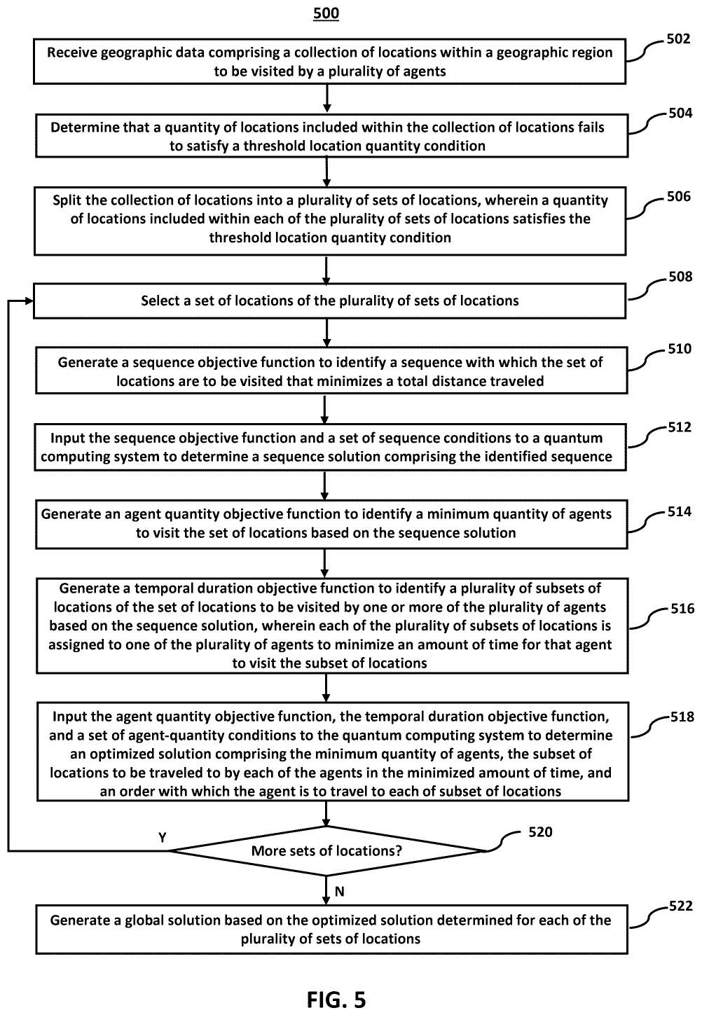

FIG. 5 illustrates a flowchart of another example method 500 for determining an optimized quantity of agents and routes for the agents using quantum computing, in accordance with various embodiments. In some embodiments, method 500 may be executed utilizing one or more processing devices (e.g., computing system 600 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other processing device(s) that may be suitable for processing genomics data, proteomics data, metabolomics data, metagenomics data, transcriptomics data, or other omics data and making one or more decisions based thereon), software (e.g., instructions running/executing on one or more processors), firmware (e.g., microcode), or some combination thereof.

In some embodiments, method 500 may begin at step 502. At step 502, geographic data indicating a collection of locations with a geographic region to be visited by an agent may be received. For example, the geographic data including locations (e.g., locations 202 of FIG. 2) may be retrieved from location database 142 and/or input by a user via user device 130. The geographic data may include longitude-latitude pairs indicating locations that are to be traveled to by an agent. For example, the locations may correspond to residences, businesses, educational institutions, and the like. An agent may travel along streets or other segments to reach each of the locations. In some examples, a task may be performed by the agent at each location (e.g., delivering an item, picking up an item, performing a service, and the like). In some embodiments, step 502 may be performed by a subsystem that is the same or similar to location subsystem 110.

At step 504, the quantity of locations included within the collection of locations may be determined to fail to satisfy a threshold location quantity condition. In one or more examples, the threshold location quantity may be determined based on a quantity of qubits implemented by quantum computing system 160. In some embodiments, quantum computing system 160 may include a plurality of qubits. For example, quantum computing system 160 may include 1,000 or more qubits, 10,000 or more qubits, 20,000 or more qubits, 50,000 or more qubits, or 100,000 or more qubits, or other quantities of qubits. In some embodiments, the threshold location quantity condition being satisfied comprises the quantity of locations being less than or equal to a threshold quantity of locations. The threshold quantity of locations may be determined based on the quantity of qubits implemented by quantum computing system 160. The threshold location quantity condition failing to be satisfied comprises the quantity of location being greater than the threshold quantity of locations. In some embodiments, step 504 may be performed by a subsystem that is the same or similar to location subsystem 110.

At step 506, the collection of locations may be split into a plurality of sets of locations. A quantity of locations included within each of the plurality of sets of locations may satisfy the threshold location quantity condition. In some examples, each set of locations may include a same or similar quantity of locations. For example, if there are 1,000 locations included in the collection of locations, then location subsystem 110 may split the 1,000 locations into 10 sets each including 100 locations. In this example, if quantum computing system 160 includes 20,000 qubits, then each set of 100 locations would satisfy the threshold location quantity condition. Upon obtaining the plurality of sets of locations each satisfying the threshold location quantity condition, each one may be analyzed using the two-step process to solving the agent route optimization problem. In some embodiments, step 506 may be performed by a subsystem that is the same or similar to location subsystem 110.

At step 508, a set of locations of the plurality of sets of locations may be selected. For example, if there are l sets of locations, each includes N locations, then a set of N locations may be selected for analysis using the two-step approach described herein. In some embodiments, step 508 may be performed by a subsystem that is the same or similar to location subsystem 110. Thus, steps 510-518 refer to steps performed for the selected set of locations. Steps 510-518 can be repeated for each set of locations of the l sets of locations.

At step 510, a sequence objective function may be generated to identify a sequence with which the set of locations are to be visited that minimizes a total distance traveled. Each agent may perform a task at each location within the set of locations. In one or more examples, the amount of time for the agent to visit each location of the subset of locations may be based on: (i) a predefined amount of time to perform the task, (ii) a quantity of locations included by the subset of locations, and (iii) a distance between each location of the subset of locations. In one or more examples, a distance matrix Dᵢⱼ comprising elements corresponding to the distance between the i-th location (e.g., node i) and the j-th location (e.g., node j) of the given set of locations. The sequence objective function may include (e.g., formulated to include) the distance matrix. In some embodiments, a plurality of distance matrices

$${D}_{ij}^{l} ,$$

where l refers to a l-th set of locations of the plurality of locations. In some embodiments, sequence optimization subsystem 112 may generate the sequence objective function by defining a cost function. In one or more examples, each cost function comprises a product of the distance matrix

$${D}_{ij}^{l}$$

and a binary matrix. A minimum of the cost function, which corresponds to an l-th Hamiltonian cycle H_{dist} having a shortest length for the given nodes (N) within the selected set of locations may be determined, where the nodes correspond to the locations to be visited by the agent within the l-th set of locations. In some embodiments, step 510 may be performed by a subsystem that is the same or similar to sequence optimization subsystem 112.

At step 512, the sequence objective function and a set of sequence conditions may be input to quantum computing system 160 to determine a sequence solution comprising the sequence. The sequence solution may correspond to an l-th sequence solution associated with the l-th set of locations selected at step 508. The sequence solution comprising the sequence may represent the shortest distance to travel to each location within the set of locations. In some embodiments, a set of sequence conditions may be defined or otherwise determined. The set of sequence conditions may include one or more conditions to be satisfied when solving for each sequence solution. For example, the set of sequence conditions may include a first condition and a second condition. The first condition may specify that each location of the plurality of locations is traveled to a single time, as illustrated by Equation 6. The second condition may specify that each location of the plurality of locations occupies a single position within the sequence, as illustrated by Equation 7. The sequence solution may represent an optimized route for an agent to take to travel to each location within the set of locations in least amount of time and/or with a shortest distance. The elements of the binary matrix may be mapped to qubits of quantum computing system 160. The sequence solution identified by quantum computing system 160 may, therefore, represent the lowest energy state of the qubits. In some embodiments, step 512 may be performed by a subsystem that is the same or similar to quantum computing interface subsystem 114.

At step 514, an agent quantity objective function may be generated to identify a minimum quantity of agents to be visit the set of locations. Each of the agents may be assigned to visit a subset of locations of the set of locations. In some embodiments, for each set of locations of the plurality of sets of locations, a first cost function comprising a binary matrix, X may be defined comprising a plurality of elements x_{i,j}. For instance, each row of the binary matrix may correspond an agent of a plurality of agents (e.g., an i-th agent) and each column of the binary matrix corresponds to a position within the sequence (e.g., a j-th position). Furthermore, each of the elements x_{i,j} can have (i) a first state indicating that, for the optimized solution, the agent travels to the location at the position (e.g., the i-th agent at the j-th position) or (ii) a second state indicating that the agent does not travel to the location at the position. The binary matrix, which may be summed across the plurality of agents to determine whether each row includes at least one element having the first state, as illustrated by Equation 8. In some embodiments, step 514 may be performed by a subsystem that is the same or similar to agent optimization subsystem 116.

At step 516, a temporal duration objective function may be generated to identify, for each of the agents, the subset of locations to be visited by the agent. In one or more examples, the subset of locations assigned to each of the agents minimizes an amount of time for the agent to visit each location of the subset of locations. In some embodiments, the temporal duration objective function may comprise the binary matrix being summed across the plurality of agents. The summation may determine: (i) a first amount of time for each of the plurality of agents to travel from a center of the geographic region to a given location of the plurality of locations, (ii) a second amount of time for each of the plurality of agents to travel from an immediately previous location to the given location, (iii) a third amount of time for each of the plurality of agents to travel from the immediately previous location to the center, as illustrated by Equation 9. Each temporal duration objective function comprises one or more components. For example, the temporal duration objective function may include a first component

$${N}_{i}^{C \to j} ,$$

a second component

$${N}_{i}^{j - 1 \to j} ,$$

and a third component

$${N}_{i}^{j - 1 \to C} ,$$

as illustrated by Equations 10-12. In one or more examples, generating the temporal duration objective function comprises combining the first component

$${N}_{i}^{C \to j} ,$$

the second component

$${N}_{i}^{j - 1 \to j} ,$$

and the third component

$${N}_{i}^{j - 1 \to C}$$

for each of the agents. In some embodiments, step 516 may be performed by a subsystem that is the same or similar to temporal optimization subsystem 118.

At step 518, the agent quantity objective function, the temporal duration objective function, and a set of agent-quantity conditions may be input to quantum computing system 160 to determine an optimized solution comprising the minimum quantity of agents traveling to each subset of locations that minimizes the amount of time. In some embodiments, each of the l agent quantity objective functions Nₐ and each of the l temporal duration objective functions Nₜ include a matrix comprising rows representing a plurality of candidate agents and columns representing candidate locations to be visited by a corresponding agent. Agents determined to not travel to at least one of the set of locations from the plurality of candidate agents may be removed, as mentioned above. In some embodiments, the set of agent-quantity conditions may include one or more conditions for quantum computing system 160 to implement when solving each of the l agent quantity objective functions and each of the l temporal duration optimization functions. For example, the set of agent-quantity conditions may include a first condition specifying that the amount of time for the agent to visit each location of the subset of locations should be less than or equal to a threshold amount of time, t_{threshold} (e.g., 4 hours, 6 hours, 8 hours, 12 hours, 24 hours, etc.), as illustrated by Equation 13. The set of agent-quantity conditions may also include a second condition specifying that each of the set of locations is included within the sequence with which the set of locations are to be visited, as illustrated by Equation 14. The set of agent-quantity conditions may still further include a third condition specifying that each location of the set of locations is visited by only one agent, as illustrated by Equation 15. Each of the l optimized solutions may include the minimum quantity of agents, the subsets of locations to be traveled to by each of the agents in the minimized amount of time, and an order with which the agent is to travel to each location within a corresponding subset of locations. In some embodiments, step 518 may be performed by a subsystem that is the same or similar to quantum computing interface subsystem 114.

At step 520, a determination may be made as to whether there are any more sets of locations to select and analyze using steps 510-518. If so, then method 500 may return to step 508 where a new set of locations from the plurality of sets of locations may be selected. If not, then method 500 may proceed to step 522.

At step 522, a global solution may be generated based on the optimized solution determined for each of the plurality of sets of locations. For instances, the l optimized solutions corresponding to the l sets of locations may be combined to obtain the global solution. Thus, the global solution may indicate a minimum quantity of agents needed to travel to each of the collection of locations, which of these agents are to travel to each of the locations, and the order with which those agents are to travel to those locations. In some embodiments, step 522 may be performed by a subsystem that is the same or similar to quantum computing interface subsystem 114.

### Example Results

Results obtained using the two-step approach described herein may be compared with a solution derived using classical approaches. For example, the genetic algorithm may be used to determine an optimized solution to the agent route optimization problem. The genetic algorithm's solution may then be compared to the solution obtained from the two-step approach for the same locations. In some embodiments, the comparison between the genetic algorithm and two-step approach's solutions may include a comparison of the total routes included, the total distance traveled, the total duration to travel the routes, and a number of routes estimated to exceed a threshold amount of time. The total routes may correspond to the minimum quantity of agents determined by quantum computing system 160 to be needed to travel to all of the locations within a threshold amount of time (e.g., less than or equal to 8 hours). The total distance corresponds to the minimum (physically and/or temporally) distance to be traveled to the locations within the routes by the agents. The total duration corresponds to the total amount of time it takes to travel the routes by the agents. A number of route assignments that exceed the threshold amount of time may also be identified. In some embodiments, routes that cause an agent to travel for more than the threshold amount of time may necessitate additional cost. For example, a corresponding agent (if human) may require lodging to ensure compliance with regulations preventing over-working.

In some embodiments, a cost metric may be defined (e.g., quantifying a monetary cost) to convert various quantities involved like distance, duration, and quantity of route assignments exceeding the threshold amount of time, into their corresponding values (e.g., dollar value). Table 2 represents an example of the conversion rates:

TABLE 2

| | Cost |
|---|---|
| Quantity | (in Dollars) |
| 1 Mile | 1.15 |
| 1 Hour | 30.00 |
| 1 Overnight (amount of time | 160.00 |
| exceeding the threshold | |
| amount of time) | |

Persons of ordinary skill in the art will recognize that different and/or additional quantities may be used and different and/or additional costs may be used. For example, 1 kilometer may also have a defined cost. Furthermore, the cost may be represented in different currencies. Here, an “overnight” refers to any route that is estimated to take longer than the threshold amount of time (e.g., 8 hours) to complete.

Table 3 illustrates an example of a comparison between a solution obtained using classical approaches, such as the genetic algorithm, and a solution obtained using the two-step approach (using quantum computing) described herein.

TABLE 3

| | | |
|---|---|---|
| | Classical | Two-Step |
| Quantity | Solution | Approach |

| Total Stops | 40 | | 40 | |
|---|---|---|---|---|
| Total Routes | 9 | | 9 | |
| Total Distance | 1379 | miles | 1320 | miles |
| Total Duration | 68 | hours | 60 | hours |

| | | |
|---|---|---|
| Number of Overnights | 1 | 1 |

In the example of Table 3, the quantity of locations analyzed is 40 locations, representing 40 nodes of a graph. At each location, an agent may perform a task. For simplicity, the same task may be performed at each location and the performed task may take a predefined amount of time to complete (e.g., 1 hour). The results of Table 3 may represent a classical solution obtained using a classical greedy genetic algorithm and an optimized solution obtained using the two-step approach described herein leveraging quantum computing system 160. As illustrated in Table, the optimized solution from the two-step approach reduces the amount of distance traveled by approximately 4.3% (59 miles) and reduces the total time to complete the tasks by approximately 11.7% (8 hours). Both approaches identified a same minimum quantity of agents and routes (9 routes).

Table 4 illustrates another example of a comparison between a solution obtained using classical approaches, such as the genetic algorithm, and a solution obtained using the two-step approach (using quantum computing) described herein.

TABLE 4

| | | |
|---|---|---|
| | Classical | Two-Step |
| Quantity | Solution | Approach |

| Total Stops | 120 | | 120 | |
|---|---|---|---|---|
| Total Routes | 26 | | 26 | |
| Total Distance | 2640 | miles | 2849 | miles |
| Total Duration | 187 | hours | 170 | hours |

| | | |
|---|---|---|
| Number of Overnights | 1 | 0 |

In the example of Table 4, the quantity of locations analyzed is 120 locations, representing 120 nodes of a graph. At each location, an agent may perform a task, similar to that of Table 3. In the example of Table 4, because locations may be split into sets of locations based on the number of locations being greater than a threshold number of locations (e.g., as defined by equation 16 based on the number of qubits of quantum computing system 160). In some embodiments, the locations (e.g., the graph of locations) may be split using K-Means clustering. Each set of locations may be processed using the two-step approach one at a time. After all of the sets of locations are analyzed, the final results may be combined to obtain the results seen in Table 4. As seen by the results, even the two-step approach includes a greater total distance (2849 miles to 2640 miles), the number of agents working an overnight (i.e., working for more than 8 hours in a day) has been reduced. Additionally, a total amount of time may be reduced by the two-step approach by approximately 9.1% (17 hours).

The comparison may be performed for each of a plurality of cities (e.g., 50 cities, 60 cities, 70 cities, 80 cities, 90 cities, 95 cities, 96 cities, 97 cities, 98 cities, 99 cities, or 100 cities), where each city may include locations. In some examples, the comparison of the classical approach and the two-step approach may be implemented using a subgraph generation algorithm to split the locations into subsets that have less than the threshold quantity of locations. For example, the subgraph generation algorithm may be used for any graph that includes more than 85 nodes, where each node refers to a location to be traveled to. The quantity 85 may be selected for practical computation purposes, and other quantities may be used. For example, for quantum computing system 160 including 20,000 qubits, the number of locations that can be analyzed may be capped at 100 locations. As the number of locations approaches the limit of 100 locations, the processing time can increase exponentially, hindering the ability to obtain a solution in practical time (e.g., due to computing timeouts, quantum state decoherence, etc.). Table 5 illustrates results of the improvements obtained using the two-step approach as compared to the classical approach.

TABLE 5

| | Percentage Improvement |
|---|---|
| Quantity | Over Classical Approach |
| Total Routes | 12.2% |
| Total Distance | 9.48% |
| Total Duration | 8.67% |

Table 6 illustrates the number of cities that have been optimized (from the 98 cities included).

TABLE 6
In terms of Distance and Time

| | |
|---|---|
| Fully Optimized | 44 |
| Not Optimized | 42 |
| Partially Optimized | 12 |

In terms of Monetary Saving

| | |
|---|---|
| Optimized | 54 |
| Not Optimized | 44 |
| Money Saved w/r/t the | $86,955.00 |
| classical approach | |
| (dollars) | |
| Money Lost w/r/t the | $6,026.00 |
| classical approach | |
| (dollars) | |

As indicated by Table 6, as the number of cities included in the geographic data increases, a large difference in cost may be obtained with respect to using the two-step approach over the classical approach. However, as the number of nodes in the graph (e.g., number of locations) analyzed by quantum computing system 160 approaches the limit (e.g., 100 locations), the difference may be negligible.

### Example Computing System

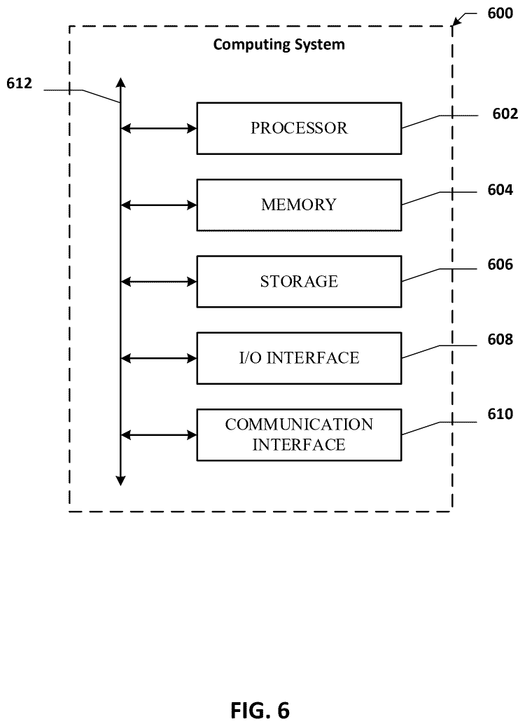

FIG. 6 illustrates an example computing system 600. In particular embodiments, one or more computing systems 600 perform one or more steps of one or more methods described or illustrated herein. In particular embodiments, one or more computing systems 600 provide functionality described or illustrated herein. In particular embodiments, software running on one or more computing systems 600 performs one or more steps of one or more methods described or illustrated herein or provides functionality described or illustrated herein. Particular embodiments include one or more portions of one or more computing systems 600. Herein, reference to a computer system may encompass a computing device, and vice versa, where appropriate. Moreover, reference to a computer system may encompass one or more computer systems, where appropriate.

This disclosure contemplates any suitable number of computing systems 600. This disclosure contemplates computing system 600 taking any suitable physical form. As example and not by way of limitation, computing system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computing system 600 may include one or more computing systems 600; be unitary or distributed; span multiple locations; span multiple machines; span multiple data centers; or reside in a cloud, which may include one or more cloud components in one or more networks. Where appropriate, one or more computing systems 600 may perform without substantial spatial or temporal limitation one or more steps of one or more methods described or illustrated herein. As an example, and not by way of limitation, one or more computing systems 600 may perform in real time or in batch mode one or more steps of one or more methods described or illustrated herein. One or more computing systems 600 may perform at different times or at different locations one or more steps of one or more methods described or illustrated herein, where appropriate.

In particular embodiments, computing system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, and not by way of limitation, computing system 600 may load instructions from storage 606 or another source (such as, for example, another computing system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computing system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computing system 600 and one or more I/O devices. Computing system 600 may include one or more of these I/O devices, where appropriate. One or more of these I/O devices may enable communication between a person and computing system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computing system 600 and one or more other computing systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, and not by way of limitation, computing system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computing system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computing system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method for determining an optimized quantity of agents and routes for the agents using quantum computing, the method comprising:
determining, using a classical computing system, a plurality of locations within a geographic region to be visited by a plurality of agents;
generating, using the classical computing system, a sequence objective function to identify a sequence with which the plurality of locations are to be visited that minimizes a total distance traveled;
inputting the sequence objective function and a set of sequence conditions into a quantum computing system to determine a sequence solution comprising the identified sequence;
generating, using the classical computing system, an agent quantity objective function to identify a minimum quantity of agents from the plurality of agents to visit the plurality of locations based on the sequence solution;
generating, using the classical computing system, a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations; and
inputting the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.

2. The method of claim 1, wherein the quantum computing system comprises a plurality of qubits, wherein a quantity of qubits included within the plurality of qubits used by the quantum computing system to determine the optimized solution is based on a quantity of locations included within the plurality of locations.

3. The method of claim 2, wherein the quantity of qubits comprises 1,000 or more qubits, 10,000 or more qubits, 20,000 or more qubits, 50,000 or more qubits, or 100,000 or more qubits.

4. The method of claim 1, further comprising:
defining a cost function comprising a binary matrix, the binary matrix comprising a plurality of elements; and
mapping the plurality of elements of the binary matrix respectively to a plurality of qubits of the quantum computing system, wherein:
each row of the binary matrix corresponds an agent of a plurality of agents and each column of the binary matrix corresponds to a position within the sequence,
each of the plurality of elements has a first value or a second value,
the first value corresponds to a first state of a qubit from the plurality of qubits indicating that, for the optimized solution, an agent of the plurality of agents travels to that location at that position within the sequence, and
the second value corresponds to a second state of a qubit from the plurality of qubits indicating that, for the optimized solution, the agent does not travel to that location at that position within the sequence.

5. The method of claim 4, wherein generating the agent quantity objective function comprises:
summing the binary matrix across the plurality of agents to determine whether each row includes at least one element has the first value.

6. The method of claim 5, wherein generating the temporal duration objective function comprises:
summing the binary matrix across the plurality of agents to determine:
a first amount of time for each of the plurality of agents to travel from a center of the geographic region to a given location of the plurality of locations;
a second amount of time for each of the plurality of agents to travel from an immediately previous location to the given location; and
a third amount of time for each of the plurality of agents to travel from the immediately previous location to the center.

7. The method of claim 6, wherein the temporal duration objective function comprises:
a first component for determining the first amount of time based on the binary matrix and a first distance matrix comprising distances from the center to each of the plurality of locations;
a second component for determining the second amount of time based on the binary matrix and a second distance matrix comprising distances from the immediately previous location to the given location; and
a third component for determining the third amount of time based on the binary matrix and a third distance matrix comprising distances from the immediately previous location to the center.

8. The method of claim 1, wherein the set of agent-quantity conditions comprises:
a first condition that the amount of time for an agent of the plurality of agents to visit each location of the subset of locations assigned to the agent is less than or equal to a threshold amount of time;
a second condition that each of the plurality of locations is included within the sequence with which the plurality of locations are to be visited; and
a third condition that each location of the plurality of locations is visited by only one agent.

9. The method of claim 8, wherein the agent performs a task at each location of the subset of locations and the task takes a predefined amount of time to complete, the amount of time for the agent to visit each location of the subset of locations assigned to the agent is determined based on: (i) the predefined amount of time to perform the task, (ii) a quantity of locations included by the subset of locations assigned to the agent, and (iii) a distance between each location of the subset of locations assigned to the agent.

10. The method of claim 1, wherein determining the plurality of locations comprises:
receiving geographic data comprising a plurality of longitudes-latitudes pairs describing the plurality of locations.

11. The method of claim 10, further comprising:
calculating, based on the geographic data, a center of the geographic region, wherein the center comprises a center longitude and a center latitude.

12. The method of claim 11, wherein the temporal duration objective function comprises:
a first component representing, for each of the plurality of agents, an amount of time for the agent to travel from the center to each of the plurality of locations;
a second component representing, for each of the plurality of agents, an amount of time for the agent to travel from an immediately prior location of the plurality of locations to each of the plurality of locations; and
a third component representing, for each of the plurality of agents, an amount of time for the agent to travel from the immediately prior location to the center.

13. The method of claim 12, wherein generating the temporal duration objective function comprises:
combining, for each of the plurality of agents, the first component, the second component, and the third component.

14. The method of claim 1, wherein the agent quantity objective function and the temporal duration objective function each include a matrix comprising rows representing a plurality of candidate agents and columns representing candidate locations to be visited by a corresponding agent.

15. The method of claim 14, wherein the minimum quantity of agents is determined from the plurality of candidate agents, the method further comprising:
removing, from the plurality of candidate agents, any agents determined to not travel to at least one of the plurality of locations.

16. The method of claim 1, wherein the agent quantity objective function and the temporal duration objective function are solved, via the quantum computing system, together.

17. The method of claim 1, wherein generating the sequence objective function comprises:
calculating a plurality of distances, wherein each distance of the plurality of distances is between two of the plurality of locations;
formulating a distance matrix comprising the plurality of distances, wherein the sequence objective function comprises the distance matrix.

18. The method of claim 17, wherein generating the sequence objective function comprises:
defining a cost function comprises a product of the distance matrix and a binary matrix, the binary matrix comprising a plurality of elements; and
mapping the plurality of elements of the binary matrix respectively to a plurality of qubits of the quantum computing system, wherein:
each row of the binary matrix corresponds an agent of a plurality of agents and each column of the binary matrix corresponds to a position within the sequence,
each of the plurality of elements has a first value or a second value,
the first value corresponds to a first state of a qubit from the plurality of qubits indicating that, for the optimized solution, an agent of the plurality of agents travels to that location at that position within the sequence, and
the second value corresponds to a second state of a qubit from the plurality of qubits indicating that, for the optimized solution, the agent does not travel to that location at that position within the sequence.

19. The method of claim 18, wherein the cost function comprises a constrained quadratic model.

20. The method of claim 1, wherein the sequence solution comprising the sequence represents a shortest distance to travel to each of the plurality of locations.

21. The method of claim 1, wherein the set of sequence conditions comprise:
a first condition that each location of the plurality of locations is traveled to a single time; and
a second condition that each location of the plurality of locations occupies a single position within the sequence.

22. A method for determining an optimized quantity of agents and routes for the agents using quantum computing, the method comprising:
receiving, using a classical computing system, geographic data comprising a collection of locations within a geographic region to be visited by a plurality of agents;
determining, using the classical computing system, that a quantity of locations included within the collection of locations fails to satisfy a threshold location quantity condition;
splitting, using the classical computing system, the collection of locations into a plurality of sets of locations, wherein a quantity of locations included within each of the plurality of sets of locations satisfies the threshold location quantity condition;
for each of the plurality of sets of locations:
generating, using the classical computing system, a sequence objective function to identify a sequence with which the set of locations are to be visited that minimizes a total distance traveled;
inputting the sequence objective function and a set of sequence conditions to a quantum computing system to determine a sequence solution comprising the identified sequence;
generating, using the classical computing system, an agent quantity objective function to identify a minimum quantity of agents to visit the set of locations based on the sequence solution;
generating, using the classical computing system, a temporal duration objective function to identify a plurality of subsets of locations of the set of locations to be visited by one or more of the plurality of agents based on the sequence solution, wherein each of the plurality of subsets of locations is assigned to one of the plurality of agents to minimize an amount of time for that agent to visit the subset of locations; and
inputting the agent quantity objective function, the temporal duration objective function, and a set of agent-quantity conditions to the quantum computing system to determine an optimized solution comprising the minimum quantity of agents, the subset of locations to be traveled to by each of the agents in the minimized amount of time, and an order with which the agent is to travel to each of subset of locations; and
generating, using the classical computing system, a global solution based on the optimized solution determined for each of the plurality of sets of locations.

23. The method of claim 22, wherein the quantum computing system comprises a plurality of qubits, the threshold location quantity condition is determined based on a quantity of the plurality of qubits.

24. The method of claim 23, wherein the threshold location quantity condition being satisfied comprises the quantity of locations being less than or equal to a threshold quantity of locations, the threshold quantity of locations being determined based on the quantity of the plurality of qubits.

25. A system for determining an optimized quantity of agents and routes for the agents using quantum computing, the system comprising:
memory storing computer program instructions; and
one or more processors programmed with the computer program instructions to:
determine a plurality of locations within a geographic region to be visited by a plurality of agents;
generate a sequence objective function to identify a sequence with which the plurality of locations are to be visited that minimizes a total distance traveled;
input the sequence objective function and a set of sequence conditions into a quantum computing system to determine a sequence solution comprising the identified sequence;
generate an agent quantity objective function to identify a minimum quantity of agents from the plurality of agents to visit the plurality of locations based on the sequence solution;
generate a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations; and
input the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.

26. A non-transitory computer-readable medium storing computer program instructions that, when executed by one or more processors, effectuate operations comprising:
determining a plurality of locations within a geographic region to be visited by a plurality of agents;
generating a sequence objective function to identify a sequence with which the plurality of locations are to be visited that minimizes a total distance traveled;
inputting the sequence objective function and a set of sequence conditions into a quantum computing system to determine a sequence solution comprising the identified sequence;
generating an agent quantity objective function to identify a minimum quantity of agents from the plurality of agents to visit the plurality of locations based on the sequence solution;
generating a temporal duration objective function to identify a plurality of subsets of locations to be visited by the minimum quantity of agents based on the sequence solution, wherein each of the plurality of subsets of locations is assigned to one of the minimum quantity of agents to minimize an amount of time for that agent to visit the subset of locations; and
inputting the agent quantity objective function, the temporal duration objective function, and a set of agent-quantity conditions to the quantum computing system to determine an optimized solution comprising the minimum quantity of agents, the subset of locations to be traveled to by each of the minimum quantity of agents in the minimized amount of time, and an order with which the agent is to travel to the subset of locations.
